(19) United States
(12) Patent Application Publication
(10) Pub. No.: US 2024/0378534 A1
(43) Pub. Date: Nov. 14, 2024

(54) EVENT LEARNING AND OPERATIONAL RISK ASSESSMENT FOR ASSET PERFORMANCE MANAGEMENT SYSTEM

(71) Applicant: Xcel Energy Inc., Minneapolis, MN (US)

(72) Inventors: Kaitlyn Jo Honey, Thornton, CO (US); Brandon Scott Diegel, Brighton, CO (US); Antoinette Marie McIlvenna, Pensacola, FL (US)

(21) Appl. No.: 18/660,572

(22) Filed: May 10, 2024

Related U.S. Application Data
(60) Provisional application No. 63/501,621, filed on May 11, 2023.

(51) Int. Cl. G06Q 10/0635

(52) U.S. Cl. CPC G06Q 10/0635

(57) ABSTRACT

Disclosed are techniques for assessing and mitigating operational risk in a facility. The techniques can include accessing asset health scores for assets in a facility that indicate a likelihood that the assets will fail or be operationally impaired, identifying criticality scores that indicate a degree of importance of the assets to facility operations, determining, based on the asset health scores and the criticality scores, operational risk scores that indicate a risk posed to the ongoing operation of the facility or to the enterprise by the asset, determining actions and corresponding action prioritizations to recommend for the assets, ranking the plurality of assets based on the operational risk scores, and outputting, in a user interface, information identifying the assets ranked based on the operational risk scores.

### CROSS-REFERENCE TO RELATED APPLICATIONS

This application claims the benefit of priority to U.S. Provisional Patent Application No. 63/501,621, filed May 11, 2023, the entirety of which is incorporated herein by reference.

### TECHNICAL FIELD

This document generally describes devices, systems, and methods related to improvements to asset performance management (“APM”) systems, which can be used to manage physical assets (i.e., equipment and other components) within complex systems, such as electrical generation units (i.e., power plants), oil and gas facilities (i.e., oil refineries), manufacturing facilities (i.e., fabrication), paper mills, mining facilities and equipment, and/or other facilities.

### BACKGROUND

APM systems have been developed to provide features related to the monitoring and reliability of physical assets, such as equipment in a facility. APM systems can interface with any of a variety of data sources, such as sensors monitoring physical assets, manual observations of the assets, and even the assets themselves, to capture data related to assets, which APM systems can process and present to users to monitor and manage the physical assets. APM systems can include user interface features to aid in optimizing cost, risk and reliability of physical assets, such as providing mechanisms through which performance issues related to assets can be presented to users and corrective action for remedying those performance issues can be initiated. APM systems can include any of a variety of hardware and software systems and devices, such as computer servers, cloud-based systems, networks, device and sensor interfaces, computing devices, and/or others.

### SUMMARY

This document generally describes technology that improves APM systems to provide the ability to better document causes and contributing factors of events related to physical assets, such as equipment that is part of energy supply units and facilities, oil and gas facilities (i.e., oil refineries), manufacturing facilities (i.e., fabrication), paper mills, mining facilities and equipment, and/or other facilities. For example, in regulated facilities that may require specific reporting related to events that occur within the facilities, such as electrical generation facilities under North American Electric Reliability Corporation (“NERC”) regulation requiring generating availability data (“GAD”) event information to be submitted for reductions in electrical production, the reported event information may be insufficient to identify the causes of such events, to identify trends, and to pinpoint specific assets, associated components and processes within such facilities that may be implicated. The disclosed technology permits for such additional information to be accurately captured, analyzed, and leveraged across an enterprise to better repair, replace, maintain, and operate equipment in a manner that remedies the causes of events and additionally avoids future events from occurring. Additionally, the disclosed technology permits for events, which may relate the broader operation of a facility or energy generation unit, to be specifically linked to particular equipment within the facility and to conditions associated with the equipment and other contextual information (e.g., observations, sensor data, data from other equipment, prior maintenance for the equipment) to appropriately and accurately determine root causes of events. Additionally, the disclosed technology permits for the identification of common trends in failures and other equipment issues, and to document and track corrective actions to mitigate future risk.

The disclosed technology provides additional improvements related to asset management, including through the assessment of operational risk related to assets that are being monitored and managed within APM system. For example, given large-scale facilities and/or enterprises with a lot of different equipment that is being managed and monitored, risks that are associated with various pieces of equipment can be challenging to assess. The disclosed technology incorporates various different scoring mechanisms that can be used to assess a variety of risks related to assets, such as an asset health score that can indicate the current health of the asset (i.e., probability that the asset will fail) and a criticality score that can indicate how critical the asset is to the facility and/or the enterprise (i.e., if asset fails, what are broader implications of the failure on broader systems). Asset health scores and criticality scores can be determined and combined for assets to determine an operational risk score, which can be used to schedule and prioritize maintenance and/or corrective action orders. For example, a piece of equipment that is critical to an energy generation unit (based on criticality score) that is beginning to show signs of wear (based on asset health score) may have a greater operational risk score than another piece of equipment that is significantly less critical to the facility but is demonstrating a greater probability of failure, and as a result maintenance and repair of the more critical asset may be identified and prioritized over the other, less critical asset. The operational risk scores can be used to assess and capture the broader implications of and risks associated with equipment failure beyond just the equipment itself failing (i.e., assessing risk of energy generation unit going down or having to operate at reduced capacity based on specific piece of equipment failing).

The disclosed technology can additionally leverage and combine the equipment failure information that is identified through the event learning process described above and throughout this document with the operational risk scores. For example, equipment failure information can be used to generate models for equipment, which can indicate patterns of failure for particular pieces of equipment, maintenance and repair schedules, and correlations between equipment health scores and failure conditions for the equipment. As a result, such models can be used to schedule maintenance and to additionally better classify/assess equipment health scores for particular pieces of equipment. Failure to perform scheduled maintenance and/or deviations from appropriate modeled health scores for particular pieces of equipment can be indicators of enhanced risk associated with the equipment, which can additionally influence and enhance operational risk scores associated with the equipment. Other combinations of equipment failure information and modeling, and operational risk scores are also possible, as described throughout this document.

One or more embodiments described herein can include a computing system for assessing and mitigating operational risk in a facility. The computing system, for example, can perform a method that includes accessing, from a database for an asset performance management (APM) system, asset health scores for a plurality of assets in the facility, wherein each of the asset health scores indicate a likelihood that a corresponding asset will fail or be operationally impaired within a threshold period of time; identifying criticality scores for the plurality of assets in the facility, wherein each of the criticality scores indicate a degree of importance of the corresponding asset to operation of the facility or an enterprise to which the facility belongs; determining, based on the asset health scores and the criticality scores, operational risk scores for the plurality of assets in the facility, wherein each of the operational risk scores indicate a risk posed to the ongoing operation of the facility or to the enterprise by the corresponding asset; determining one or more actions and corresponding action prioritizations to recommend for each of the plurality of assets based, at least in part, on the operational risk scores; ranking the plurality of assets based on the operational risk scores; outputting, in a user interface, information identifying the plurality of assets ranked based on the operational risk scores, wherein the information includes the operational risk scores, the one or more actions for each of the plurality of assets, and the action prioritizations for the one or more actions.

In some implementations, this and other embodiments described herein can optionally include one or more of the following features. For example, the one or more actions can include corrective actions. The one or more actions can include maintenance actions. The information can include one or more selectable features, selection of which schedules work orders for the one or more actions. The APM system can be configured to track performance of the work orders. The information can additionally include the asset health scores and the criticality scores. The asset health score can be continually updated based on sensor signals related to the plurality of assets, operation information for the assets, observations of the assets, and work status information indicating whether work orders scheduled for the plurality of assets have been performed and completed within prescribed timeframes. The asset health score for an asset can be decreased in response to work orders scheduled for the asset not having been performed within the prescribed timeframes. The facility can be part of a plurality of facilities that service a common region, and the criticality score can further indicate a degree of importance of the facility to the service provided to the common region. The plurality of components can each be positioned within a hierarchy of systems and subsystems within the facility. The criticality score can be identified based on criticality information relating degrees of importance of systems, subsystems, and assets to each other within each level of the hierarchy. The instructions can be executed as a configuration or application that is run on the APM system. The instructions can be executed separate from the APM system and can be configured to interface with the APM system over one or more networks.

In another embodiment, the computing system, for example, can perform a method that includes accessing, from a database for an asset performance management (APM) system, event reporting data for an event resulting in reduction of production or other business consequence by the facility; outputting, in a user interface, prompts for one or more authorized workers in the facility to provide additional information related to the event, wherein the prompts include identification of one or more assets within the facility that are associated with the event; storing, in the database for the APM system, the additional information and associations between the event reporting data, the additional information, and identifiers for the one or more assets; determining, based on the additional information and the event reporting data, one or more corrective actions for each of the one or more assets; and outputting, in the user interface, the one or more corrective actions for each of the one or more assets, wherein the one or more corrective actions is output with selectable features, selection of which, causes work orders to be scheduled for the for the one or more corrective actions.

In some implementations, this and other embodiments described herein can optionally include one or more of the following features. For example, the APM system can be configured to track and manage performance of the work orders. The method can include generating, based on (i) the event reporting data, the additional information, and the one or more corrective actions for the one or more assets and (ii) data for other similar assets, asset models for the one or more assets, wherein the asset models represent trends and issues for assets of a common type. The method can include automatically generating, based on the asset model, one or more prospective actions for the other similar assets, wherein the one or more prospective actions are configured to address the trends and issues for the modeled assets. The instructions can be executed as a configuration or application that is run on the APM system. The instructions can be executed separate from the APM system and can be configured to interface with the APM system over one or more networks. The event reporting data can include generating availability data (GADS) event reporting data.

The devices, system, and techniques described herein may provide one or more of the following advantages. For example, the disclosed technology GADS event data can be annotated and enhanced with additional event data, to facilitate the identification of common causes of failure, the identification of patterns in the causes, and the prevention of future problems. In another example, the relative criticality of equipment to a broader facility and/or enterprise can be determined and combined with equipment health information, which can be derived from sensor data and other current information associated with the equipment, to generate an operational risk score for the equipment, which can indicate a broader risk associated with the equipment's failure that can be factored to appropriately prioritize the servicing of assets and investment decisions across facilities and/or the broader enterprise. Knowledge can be shared across an organization, and processes can be improved to mitigate possible future events based on learning from past events.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-B are conceptual diagrams of systems for better identifying and assessing risks associated with assets in facilities that are managed by an APM system.

FIGS. 2A-2C are conceptual diagrams of example systems for prioritizing the servicing of equipment in a power generation environment to optimize equipment performance, based on equipment health and criticality data.

FIG. 3A is a conceptual diagram of an example system for issue lifecycle management in a power generation environment, including a feedback loop for machine learning improvement.

FIG. 3B is a conceptual diagram of an example process flow for issue lifecycle management in a power generation environment.

FIGS. 4A-4K are example GUIs for determining causes and applying corrective actions for events in a power generation environment.

FIGS. 5A-5L are example GUIs for presenting operational risk factors that have been determined for a power generation environment.

FIG. 6 is a chart that outlines possible relationships between risk knowledge and event occurrences.

FIG. 7 is a flowchart of an example process for creating automated tasks.

FIGS. 8A-8E are example data structures for determining operational risk factors, based on equipment health and criticality data.

FIG. 9 is a schematic diagram that shows an example of a computing device and a mobile computing device.

Like reference symbols in the various drawings indicate like elements.

### DETAILED DESCRIPTION OF ILLUSTRATIVE EMBODIMENTS

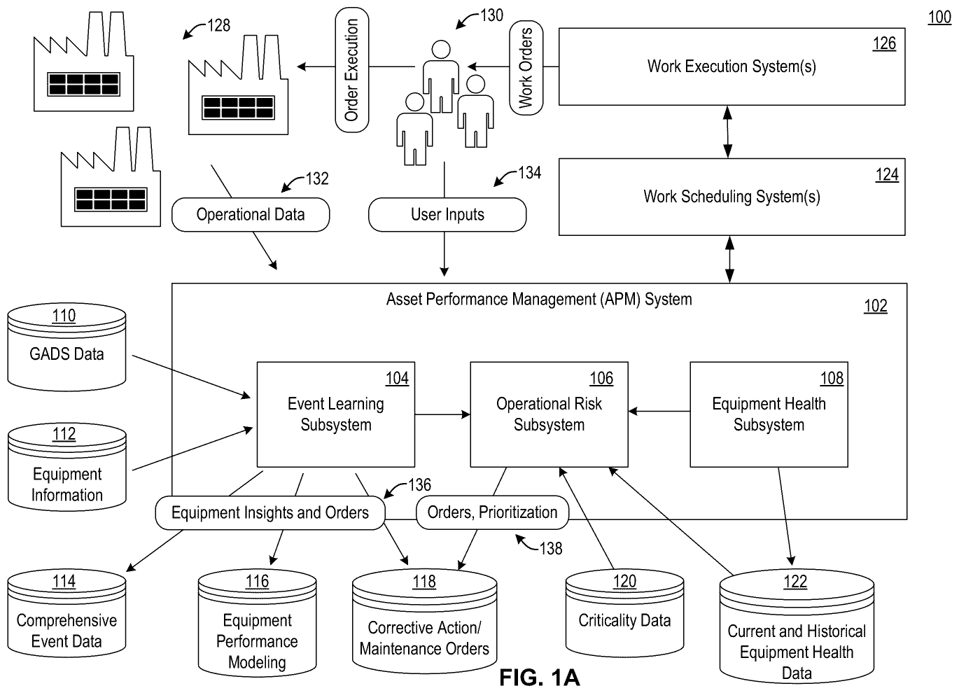

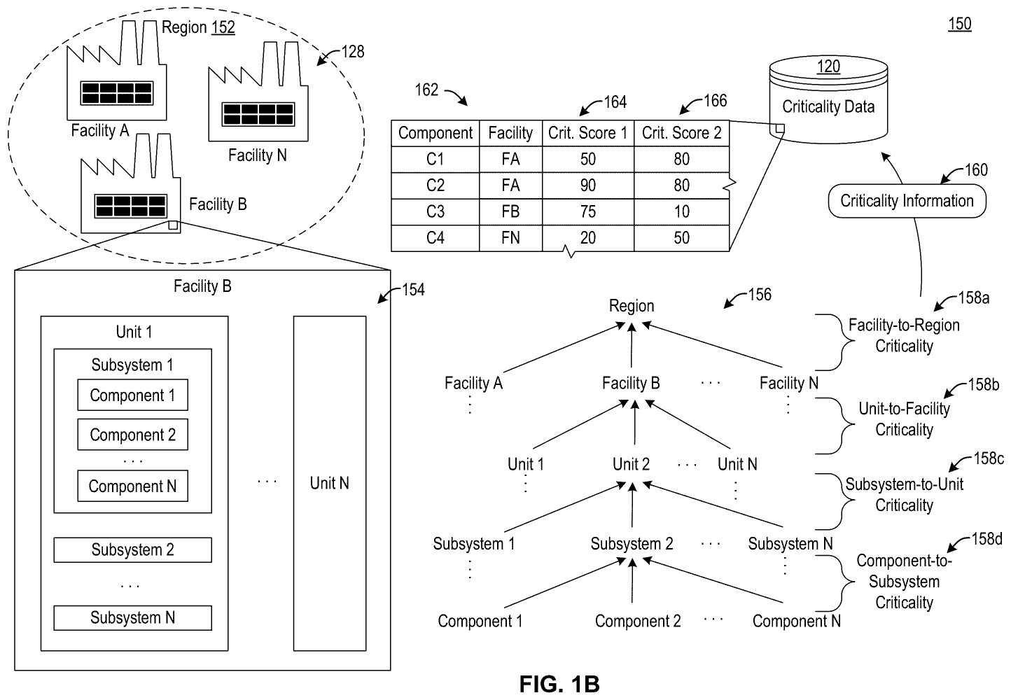

FIGS. 1A-B are conceptual diagrams of systems 100 and 150 for better identifying and assessing risks associated with assets in facilities 128 that are managed by an APM system 102.

Referring to FIG. 1A, the system 100 includes an APM system 102 that is configured to manage equipment (assets) that are part of facilities 128, which can be any of a variety of facilities, such as energy generation facilities (i.e., nuclear power plant, coal power plant, wind turbines, solar power plant, hydro-electric power plant), oil and gas facilities (i.e., oil refineries), manufacturing facilities (i.e., fabrication), paper mills, mining facilities and equipment, and/or other facilities. The APM system 102 can include a variety of components itself, such as computer servers, network and sensor interfaces, user computing devices, databases, and/or other devices/services/systems, which are configured to receive equipment information and use that information to monitor and manage the equipment in the facilities 128. For example, the APM system 102 can receive operational data 132 from the equipment at the facilities 128, which can include information from the equipment itself (e.g., current state of operation and conditions within the equipment), from sensors that are configured to monitor the equipment (e.g., vibration sensors, cameras, temperature sensors), and/or other information that indicates the current operation and/or condition of equipment within the facilities 128. The APM system 102 can additionally receive user inputs 134 from workers, managers, and/or other users 130 who are either working at the facilities 128 and/or who are managing the facilities 128. Such user input 134 can include, for example, observations and inspection reports for equipment, confirmation of the performance of various maintenance, repair, and/or replacement orders, and/or other user input that may indicate the health or condition of the equipment, or facility more broadly.

The APM system 102 can include an event learning subsystem 104, an operational risk subsystem 106, and an equipment health subsystem 108, which can each be implemented in any of a variety of ways with regard to the APM system 102. For example, the event learning subsystem 104, the operational risk subsystem 106, and/or the equipment health subsystem 108 can each be an application and/or programmed configuration that is built on top of, installed on, and/or otherwise run by an existing APM system 100, can be integrated into the source code of the APM system 100, and/or can be implemented as a standalone system that interfaces with the APM system 100. Any of a variety of configurations are possible.

The event learning subsystem 104 can capture event details and causes for lost generation events, environmental events, and safety events, which can be associated with specific equipment within the facilities 128. For example, the event learning subsystem 104 can receive GADS data 110, which can include information regarding events in the facilities 128 requiring NERC reporting, and can associate those events with specific equipment within the facilities 128 using equipment information 112 (e.g., equipment identifier, model, make, installation date, facility, maintenance history, event history). The event learning subsystem 104 can capture additional information related to events (beyond what is provided in the GADS data 110) through various dashboards and user interfaces, as described throughout this document. Additionally and/or alternatively, such additional information may be automatically identified and determined, such as through the use of machine learning and/or artificial intelligence models that are configured to identify the additional information based on, for example, the operational data 132, equipment health information, and/or other equipment and event information. Such machine learning and/or AI models may be trained on, for example, the additional information provided through manual input through the various dashboards and user interfaces using any of a variety of appropriate training techniques.

The event learning subsystem 104 can automatically calculate event generation impact related to associated equipment and can allow for the creation of corrective actions for equipment that is directly linked to the event, as indicated by 136. For example, the additional information related to events, including links between the GADS event data 110 and the equipment information 112, as well as additional information associated with the event, can be stored in a comprehensive event database 114. The event-related information can be used to generate and/or update models 116 for the equipment implicated in the event, which can combine event and other performance information for the same or similar pieces of equipment that are installed across the facilities 128. For example, patterns of equipment failure and/or other issues can be captured in the modeling 116, and/or the impact (positive or negative) of various conditions related to the equipment, maintenance, and/or other factors, which can be used to schedule proactive maintenance and/or corrective action orders 118 in the specific equipment that is implicated in an event or other similar/same pieces of equipment in other facilities 128. The event learning subsystem 104 can additionally provide dashboards to display data, track approval process, track compliance to various policies, and track status and due date of corrective actions.

The equipment health subsystem 108 can generate equipment health scores that indicate the current state of specific pieces of equipment in the facilities 128. The equipment health scores can be generated in real time (or near real time) based on the operational data 132, the user inputs 134, and/or other equipment information. The equipment health scores can indicate a risk (likelihood) that a particular piece of equipment will fail or be operationally impaired in the near future. The equipment health scores can combine a variety of different signals and factors, which can be weighted in any of a variety of ways, as described throughout this document. The equipment health subsystem 108 can store the equipment health scores in an equipment health databases 122, which can include the current and/or historical health scores for equipment in the facilities 128. For example, the current health score may indicate a current risk of the equipment, and the historical health scores, including trends and patterns over time, changes correlated to particular events and/or work orders (i.e., maintenance), and/or the rate of change of the health scores (i.e., rapid increase or decrease in health score), can additionally inform and indicate risks associated with the equipment.

The operational risk subsystem 106 can determine operational risk scores associated with equipment in the facilities 128—meaning the potential impact on the broader facility, enterprise, and/or systems of a particular piece of equipment failing—and can use the operational risk scores to prioritize, schedule, direct, and track work orders to mitigate those operational risks. In addition, the operational risks can be used to plan and prioritize future asset investments through projects, overhauls and capital replacements. The operational risk subsystem 106 can combine the equipment health scores with criticality scores for equipment, which can be determined from criticality data 120 that represents how critical a particular piece of equipment is to broader subsystems, units, facilities, regions, and/or other systems. As described throughout this document, the operational risk score for a piece of equipment can be determined from the equipment health score (i.e., current equipment health score and/or historical equipment health scores) and the criticality score for a piece of equipment, which can be used to generate and prioritize orders 138 for proactive and/or corrective action 118.

The operational risk subsystem 106 can additionally use information determined from the event learning subsystem 104 to determine operational risk scores. For example, performance of and/or failure to perform proactive maintenance on equipment based on the event learning (i.e., maintenance to prevent pattern of failure in equipment represented in the modeling 116) can either indicate an increase or decreased operational risk for the equipment. Similarly, the existence of various conditions identified in the modeling 116 that indicate enhanced and/or decreased risks associated with a piece of equipment (e.g., patterns of equipment health scores, thresholds of health scores for other equipment that may impact the operation/health of the modeled equipment) can additionally be used to increase and/or decrease the operational risk for the equipment. Other signals from the event learning subsystem 104 can additionally and/or alternatively be used.

The APM system 102 can interface with one or more work scheduling systems 124 and work execution systems 126, which can direct work orders to be executed by the workers 130, which can include manual workers, robotic operators (e.g., devices that are configured to execute physical actions without the direct control of a human operator), computer systems, and/or combinations thereof. The performance of the work orders can be recorded in one or more of the databases 110-122, and can be used as part of a feedback loop to assess the efficacy of the work orders in terms of equipment health and to remedy issues that led to events within the facilities 128.

Referring to FIG. 1B, a conceptual diagram is depicted of an example system 150 showing criticality data 120 that can be used to determine criticality scores 164, 166 for equipment within the facilities 128. In the depicted example, the facilities 128 are depicted as servicing (i.e., generating electricity) a common a region 152 (i.e., city, state, metropolitan area). Although the facilities 128 are separate and independent from each other, their performance may impact the broader region 152 that they are serving. Some of the facilities 128 may be more critical to the service provided to the region 152 than others, such as one of the facilities 128 may be more critical to providing the service (i.e., electricity production) to the region 152 than others such that a reduction in performance by that more critical facility may have a more significant impact on the service to the broader region 152.

As depicted in the example facility 154, each facility can include a hierarchy of equipment, such a facility containing multiple units (i.e., energy generation units, such as turbines), which can each contain multiple subsystems, which can each contain multiple components. Other hierarchies and relationships among equipment in a facility are also possible. Criticality relationships can also be represented within this hierarchy. For example, the criticality of each unit to the broader production by the facility can be assessed, the criticality of each subsystem to the unit can be determined, and the criticality of each component to the subsystem can be identified, as represented in the graph 156 showing criticalities 158a-d between equipment in the hierarchy. Each one of the criticalities 158a-d can be determined through any of a variety of manual and/or automated techniques, such as through assessing facility regulations and standards, through empirical evidence and data correlating events to particular pieces of equipment, and/or through machine learning and/or AI techniques. The criticality information 160, which can include one or more of the criticalities 158a-d quantified, can be stored as criticality data 120, and which can be used to generate criticality scores 164, 166 for the equipment. In the depicted example, two criticality scores 164, 166 are shown, but other numbers of criticality scores can be used and generated. For example, the criticality score 164 may represent the criticality of equipment to the facility by combining criticalities 158b-d, and the criticality score 166 can represent the criticality of the facility to the region 152 based on the criticality 158a. Various combinations and/or assessments of the criticalities 158a-d to generate the criticality scores 164, 166 can be used.

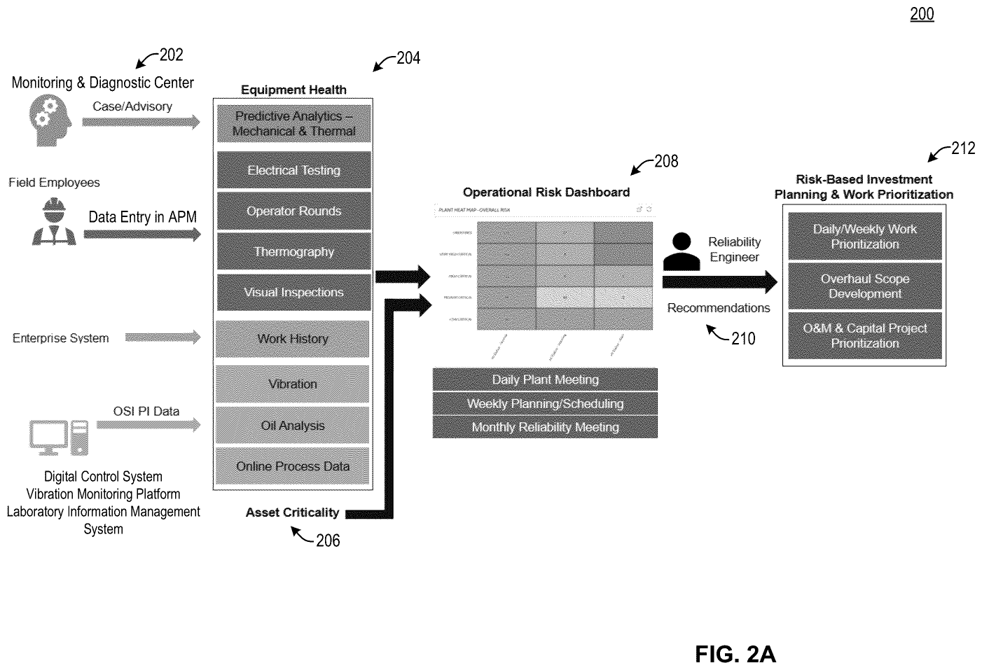

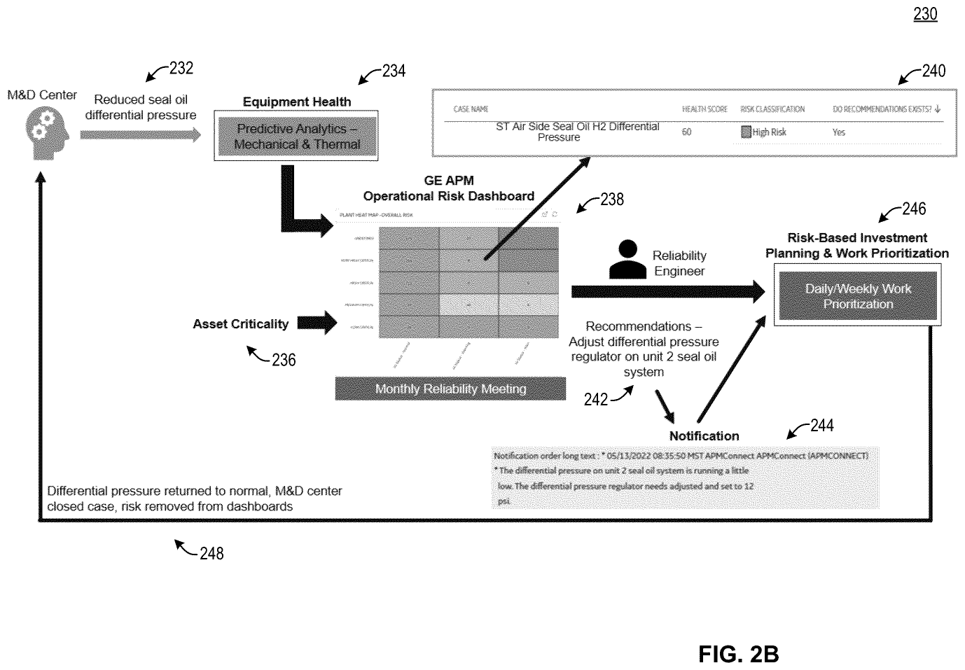

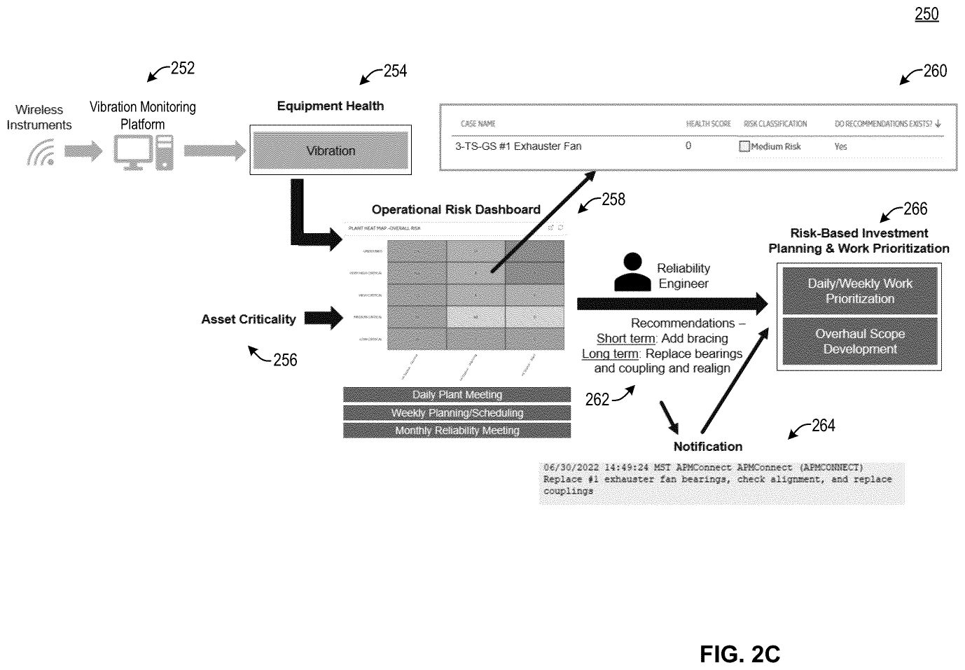

FIGS. 2A-2C are conceptual diagrams of example systems for prioritizing the servicing of equipment in a power generation environment to optimize equipment performance, based on equipment health and criticality data.

Referring to FIG. 2A, the example system 200 includes a variety of data sources 202 that are used by an equipment health subsystem 204 to generate equipment health scores that are combined with asset criticality scores 206 to provide operational risk scores and dashboards 208. The operational risk scores and dashboards 208 can be used to generate work orders/recommendations, which can be prioritized based on the operational risk posed by the equipment (212). Recommendations can be created manually and/or automatically through machine learning and/or AI techniques.

Referring to FIG. 2B, the example system 230 is an illustrative example related to a specific piece of equipment that is part of an energy generation unit. The input 232 indicates that there is a reduced seal oil differential pressure, which is used by the equipment health subsystem 234 to generate an equipment health score of 60 for the equipment. The asset criticality 236 for the equipment is high, which results in the operational risk 238 for the equipment being determined to be “high risk” (240), which carries with it a recommendation for action to be taken. The recommendation 242 is generated and a notification in the work scheduling and execution system 244 is provided for the work to be performed 246, which then results in subsequent monitoring of the condition of the equipment (248) to ensure that the operational risk for the equipment has been reduced.

Referring to FIG. 2C, another illustrative example system 250 involves sensor readings for an exhauster fan indicating vibration (252), which is determined to present a low health score of 0 by the equipment health subsystem 254. Combined with the asset criticality score of high for the equipment 256, the operational risk 258 for the equipment is determined to be medium risk with a recommendation for corrective action 260. The corrective action includes a short and long term work order 262, which results in notifications 264 being generated and work orders being scheduled/executed for both issues 266.

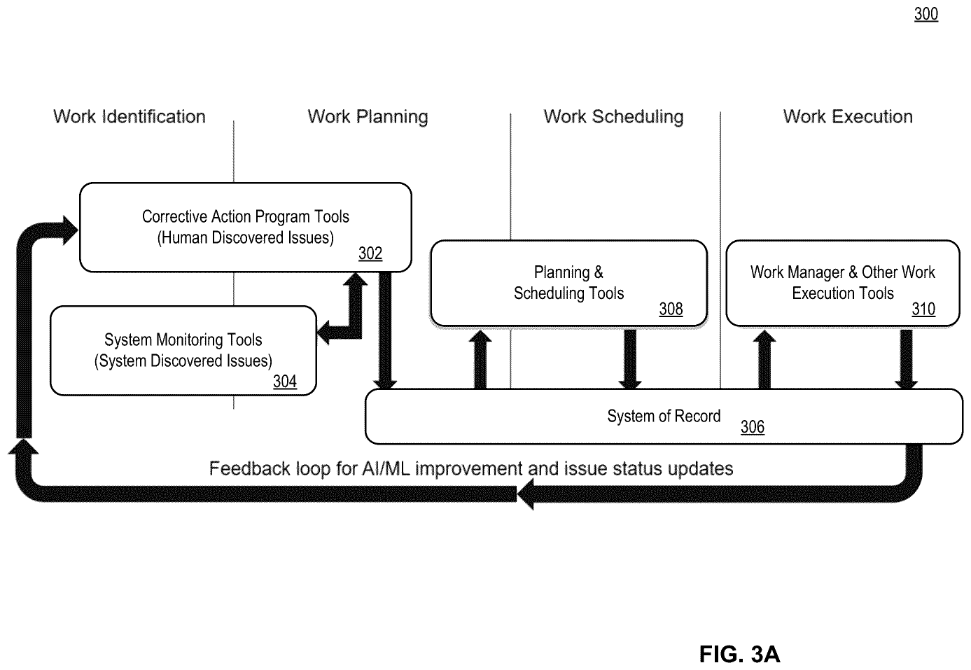

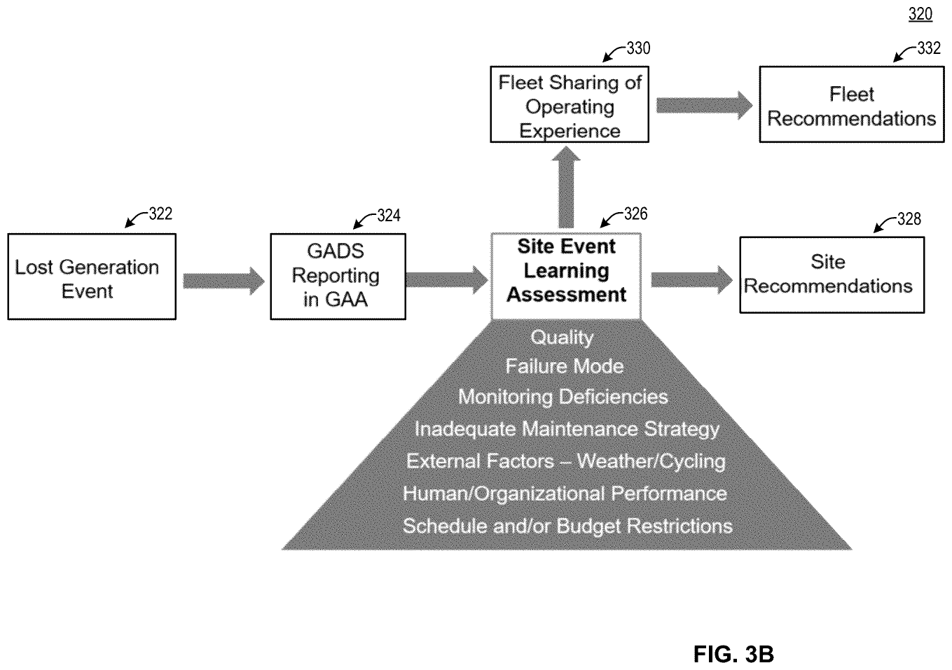

FIG. 3A is a conceptual diagram of an example system 300 for issue lifecycle management in a power generation environment, including a feedback loop for machine learning improvement. The example system 300 demonstrates that phases of asset and equipment management, and the interplay between different systems for remedying those issues. The phases include work identification (identifying problems and issues with equipment), work planning (figuring out a plan for remedying the problems and issues), work scheduling (placing orders and timelines for the work), and work execution (performing the work orders). Automatically/system discovered issues can be managed by system monitoring and management tools 304, such as APM systems and other systems, which can additionally be used for human discovered issues. Other systems can also interface with the monitoring tools 304, including other systems that are designed specifically for human discovered issues, such as corrective action program tools (302) like CAP IA developed by Xcel Energy Inc. These systems can work together or separate to identify and plan work, which can then interface with a system of record 306 to direct planning/scheduling tools 308 (e.g., OWM, RTSE) and execution tools 310 (FE&E, Work Manager) for work order execution. A feedback loop can be provided that is configured to use AI and/or machine learning to refine models, configurations, and weightings that are used by the automated and manual management tools 302-304 based on the determinations by the automated and manual management tools 302-304 and the resulting impact of work orders that are scheduled and performed based on those determinations (by the planning/scheduling and execution tools 308-310).

FIG. 3B is a conceptual diagram of an example process flow 320 for issue lifecycle management in a power generation environment. In general, the example process flow 320 can facilitate the identification of operational trends throughout an organization, such that recurring issues (that may indicate systemic problems) can be appropriately handled and resolved. Referring to the example process flow 320, at 322, a lost generation event occurs. For example, a piece of equipment in a facility can experience a failure, which causes the facility to lose power generation capabilities. Other types of events that may occur at 322 include environmental events and safety events that impact the piece of equipment and/or the facility. At 324, generating availability data (GADS) reporting can occur in a Generation Availability Analysis (GAA) platform. For example, the lost generation event (or other sort of event) can be reported using various GUIs (Graphical User Interfaces) that are described with respect to examples presented below.

At 326, a site event learning assessment can be performed. In general, the site event learning assessment can include the evaluation of various factors that are related to the lost generation event (or other sort of event). In the present example, quality factors (e.g., in relation to the piece of equipment and its component parts), failure mode factors (e.g., a type of failure that occurred), monitoring deficiencies factors (e.g., in relation to how the piece of equipment is being monitored), maintenance strategy factors (e.g., a determination of an adequacy of the maintenance strategy with respect to the piece of equipment), various external factors (e.g., weather, cycling, etc.), human/organizational performance factors, and schedule and/or budget factors. The site learning assessment can include human facilitated and/or machine learning tools (e.g., by using the various factors related to the event occurrence to train a machine learning model that is configured to identify associations between particular events and particular factors), to identify root causes for the event occurrences, and to identify possible remedies. At 328, for example, site recommendations (e.g., tasks or actions that are recommended to be performed to rectify the event and/or to prevent a future occurrence of the event) can be generated (e.g., through the use of GUIs and/or automated generation techniques as described throughout this document), can be linked to the originating event, and can be propagated throughout the system.

At 330, a fleet sharing of operating experience can be performed. In the present context, a fleet generally refers to a group of similarly configured power generation units or other equipment. While some recommendations may be applicable to a particular power generation unit at a particular site, for example, other recommendations may be broadly applicable to multiple different power generation units across multiple different sites (e.g., across the entire fleet). The fleet sharing of operating experience, for example, can involve that participation of a committee that reviews the results of the site event learning assessment at a high level (at 326), and selects events and corresponding recommendations that are more broadly applicable across the organization. At 332, for example, fleet recommendations (e.g., similar tasks or actions that are recommended to be performed across multiple different power generation units) can be generated (e.g., using similar mechanisms as the site recommendations described above), and can be propagated throughout the system (e.g., using a data loader that generates a batch of recommendations that are applicable to multiple different power generation units or other equipment). Thus, knowledge can be shared across an organization, and processes can be improved to mitigate possible future events based on learning from past events (e.g., by proactively correcting vulnerabilities).

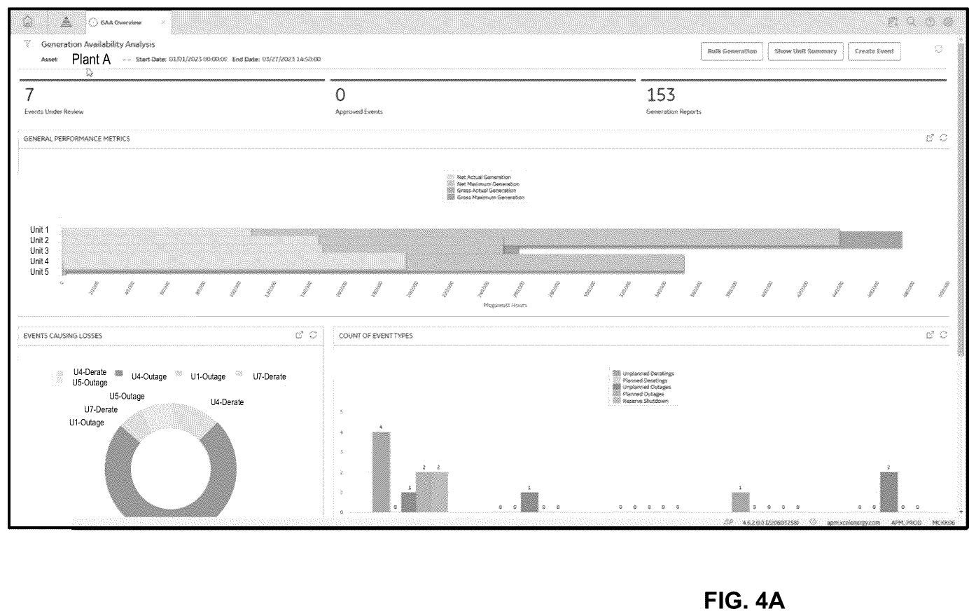

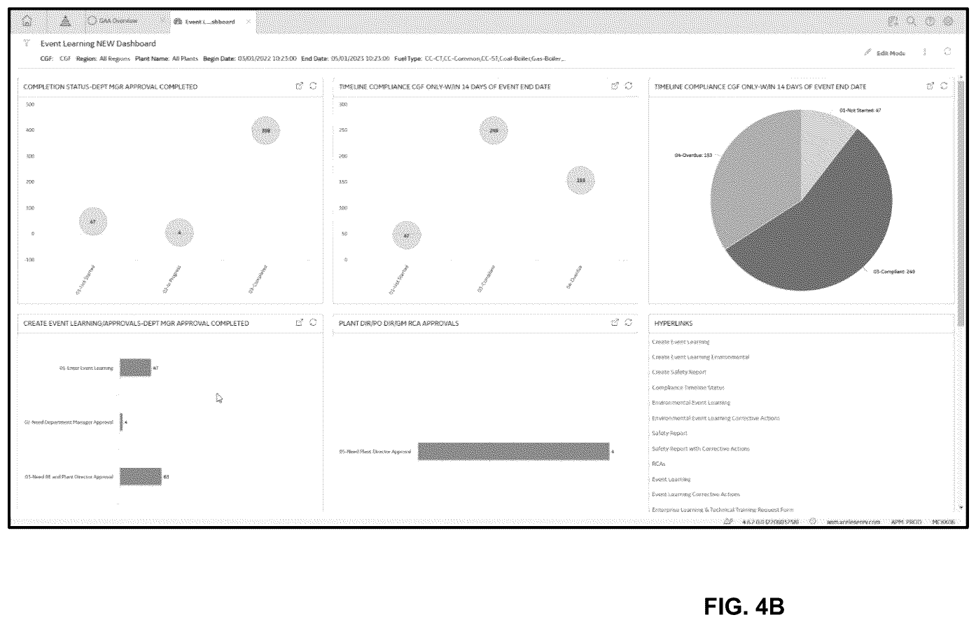

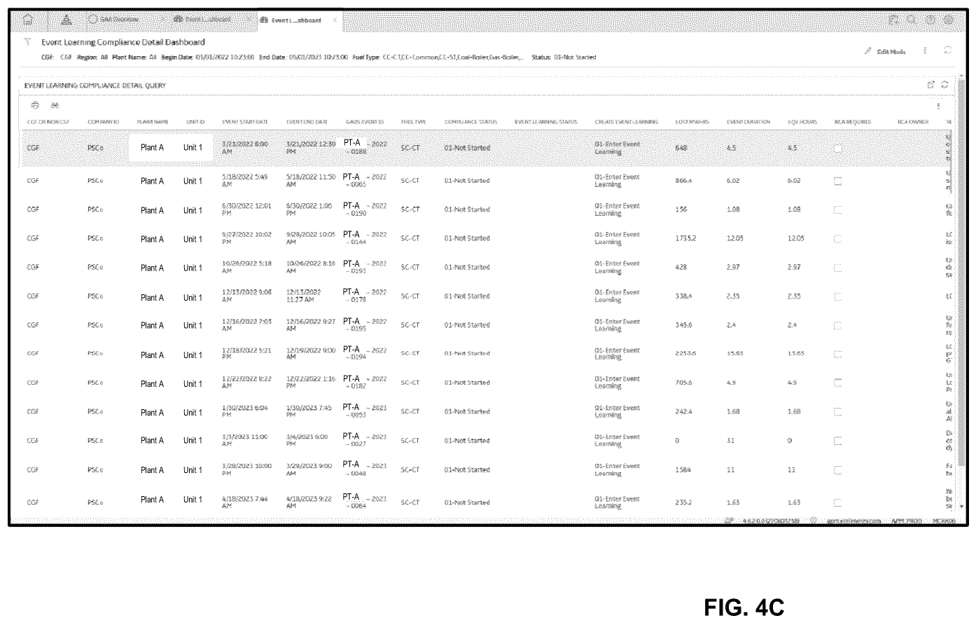

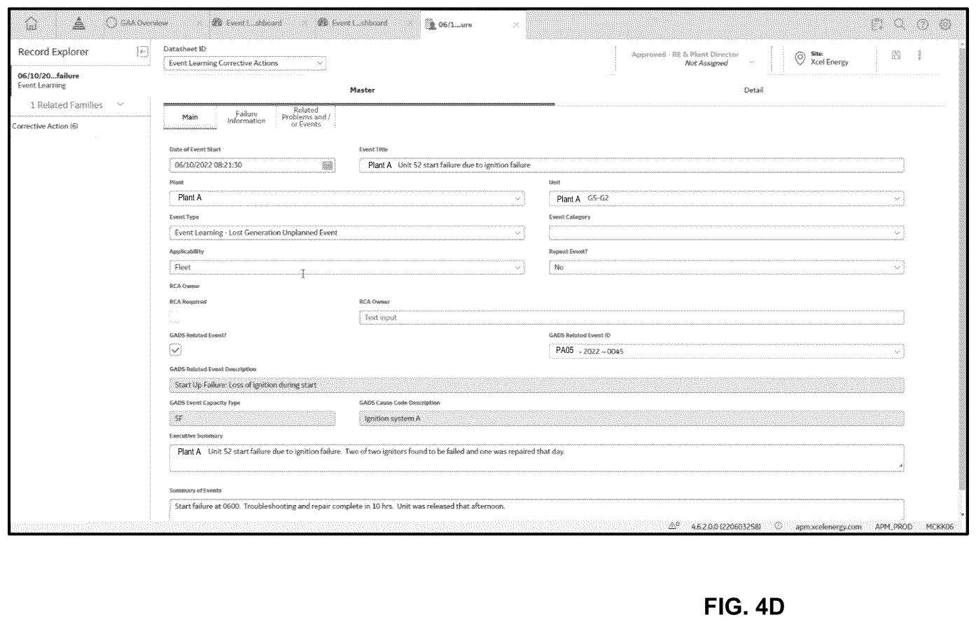

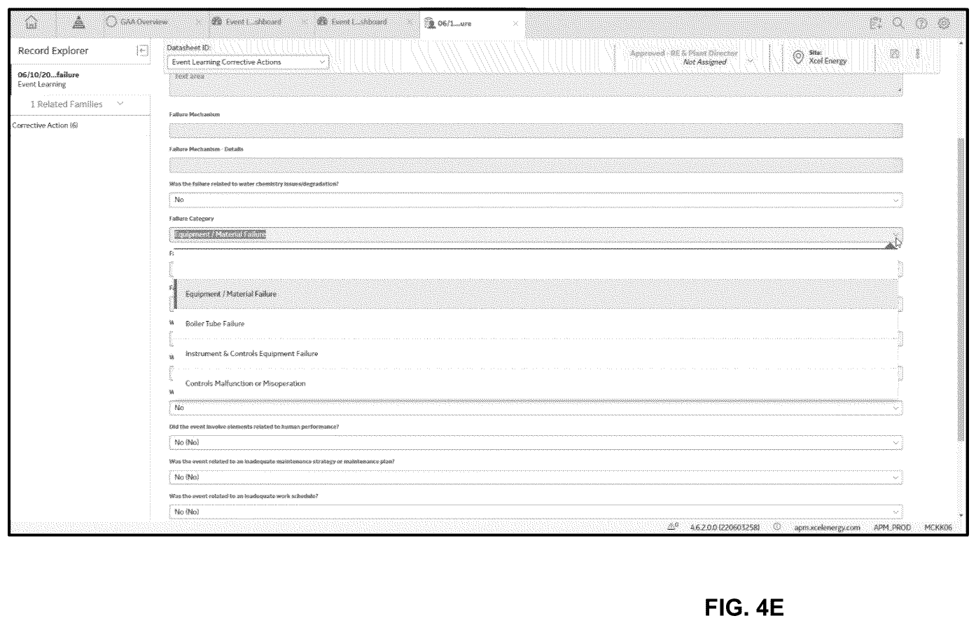

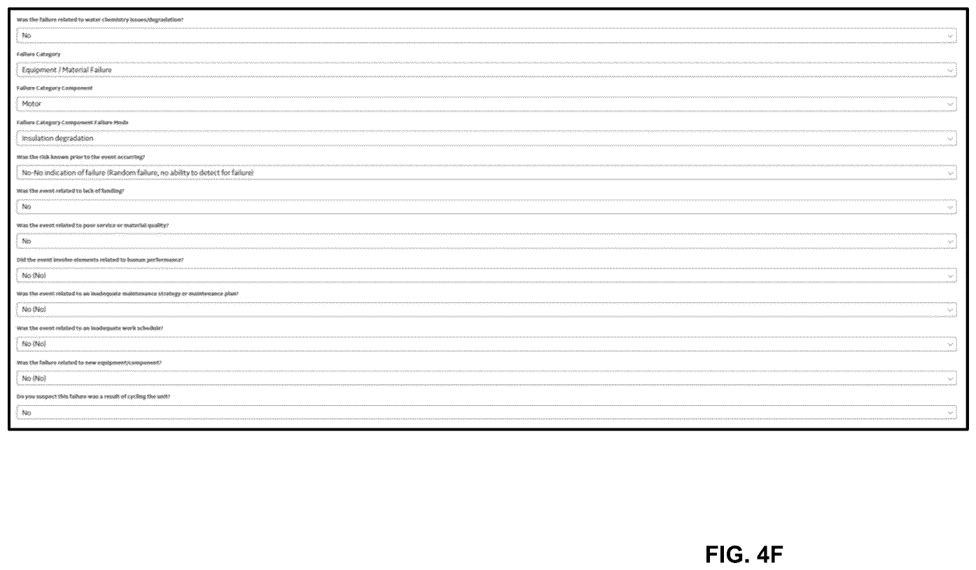

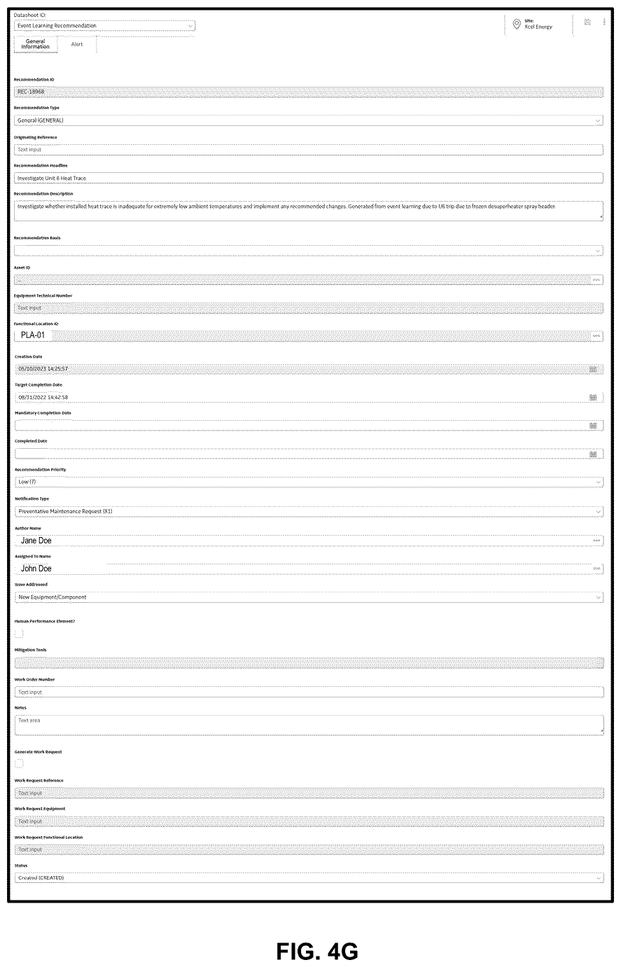

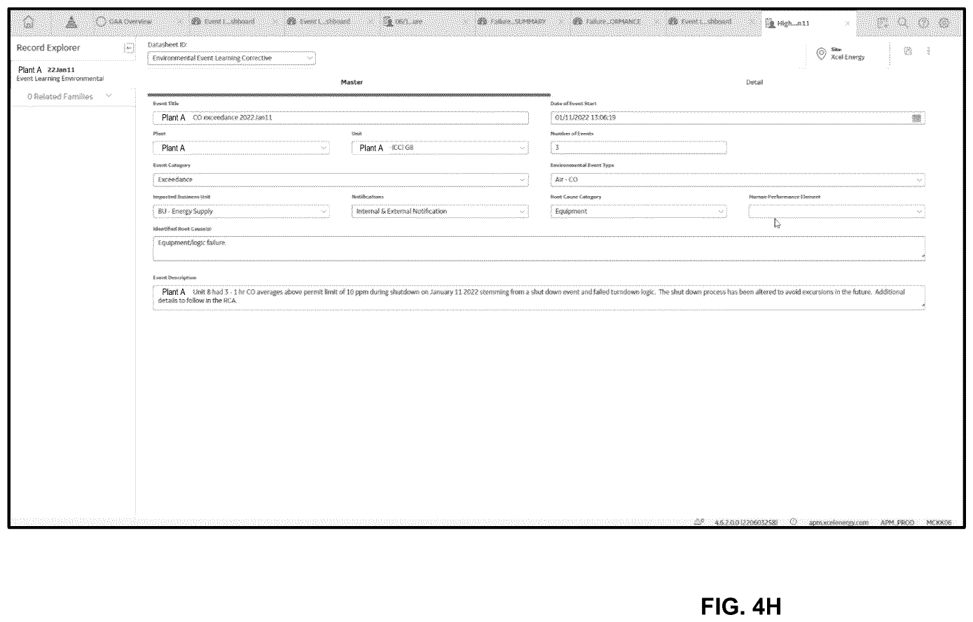

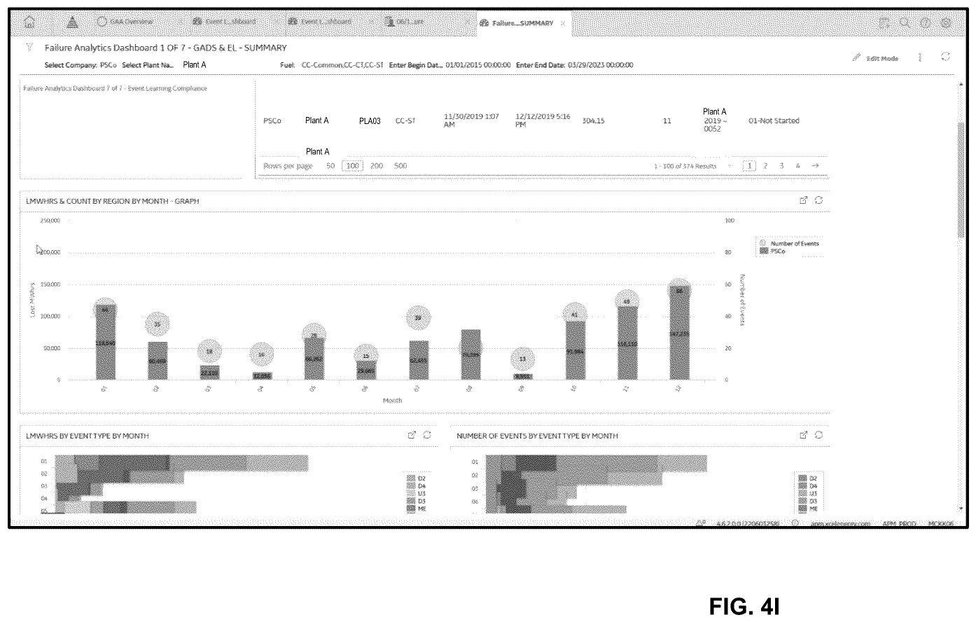

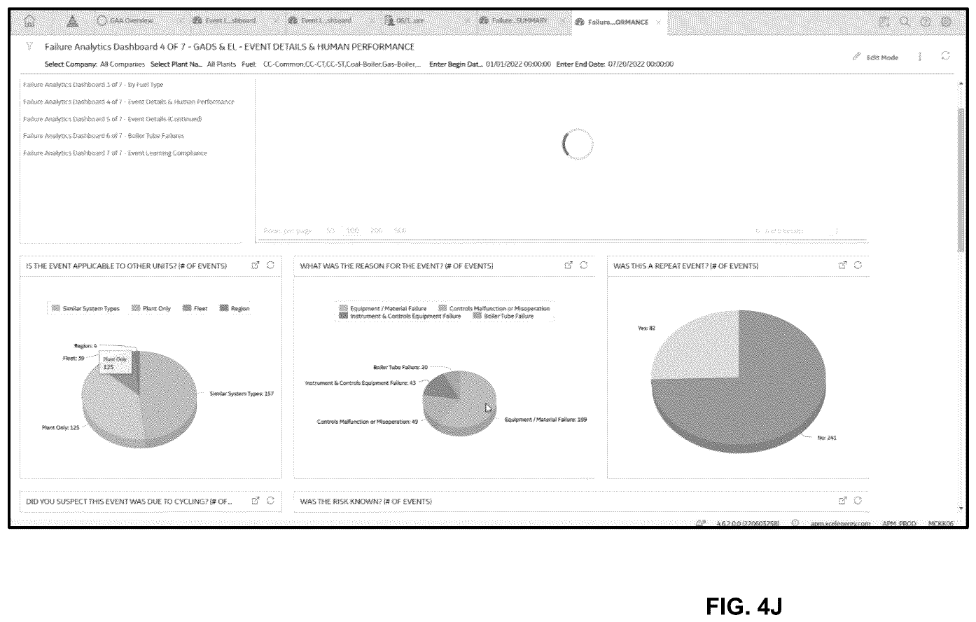

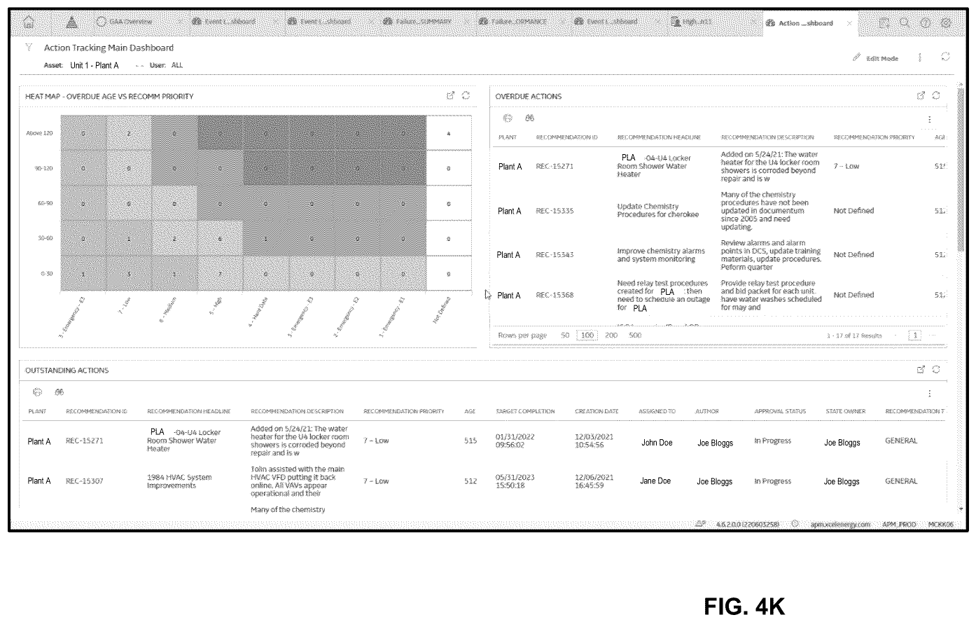

Referring to FIGS. 4A-4K, example GUIs (Graphical User Interfaces) are shown for determining causes and applying corrective actions for events that can occur in a power generation environment. In general, the GUIs can facilitate the identification of common trends in equipment failures, and can facilitate the documentation, tracking, and application of corrective actions to mitigate future risk. Various dashboards, data entry tools, and reporting tools of the GUIs can capture the details of the events (e.g., occurrences within the power generation environment, such as lost power generation events, environmental events, safety events, and other occurrences). The GUIs can be used to automatically calculate event generation impact, to facilitate the generation of corrective actions linked to the event, and to facilitate the implementation and prioritization of the corrective actions.

Referring now to FIG. 4A, for example, a GUI (Graphical User Interface) can present a Generation Availability Analysis (GAA) dashboard for use in a power generation environment. In general, the power generation environment can be logically organized such that the environment includes one or more regions (e.g., geographic areas), with each region including one or more plants (e.g., power generation facilities), with each plant including one or more units (e.g., power generation equipment, such as generators, wind turbines, solar arrays, etc.), and with each unit including various component parts. In the present example, the GAA dashboard can present various metrics for the power generation equipment of a selected power generation facility (e.g., Plant A), such as general performance metrics (e.g., power generation metrics), aggregated events causing losses, and counts of event types. Event data (e.g., pertaining to lost generation events) can be reported through the GAA dashboard, for example, and the corresponding event data can be annotated and enhanced. The depicted GAA dashboard can be part of a pre-existing AMP system, but can be improved using the annotated and enhanced event data that is described throughout this document to perform corrective actions to improve the equipment and operations of the power generation environment.

Referring now to FIG. 4B, for example, a GUI can present an Event Learning dashboard for use in the power generation environment. In general, the Event Learning dashboard can be used by a worker in the power generation environment (e.g., a manager, an engineer, or another sort of worker) to identify events that have occurred and to quickly access the relevant event data. Through use of the Event Learning dashboard, for example, a user can receive a high-level overview of event mitigation processes that are performed in the power generation environment, including event learning processes, approval processes, compliance processes, task definition processes, and task completion processes. For example, the user can use the Event Learning dashboard to identify event records that are to receive input from the user (e.g., data annotations, review, approval, etc.). Further, the Event Learning dashboard can facilitate periodic review of event data, to ensure data quality and to identify data trends that can be shared and applied across the enterprise.

Similar to the Generation Availability Analysis dashboard, for example, a user can specify various data filter parameters in the Event Learning dashboard. For example, the user can interact with one or more controls of the GUI to select a particular region in the power generation environment, and once the particular region has been selected, the user can interact with one or more controls to select one or more plants of the selected region. In the present example, all regions and all plants have been selected for the power generation environment, across a specified date range. The GUI can be updated to present various graphical representations (e.g., bar graphs, pie charts, etc.) of aggregated event data that matches the specified data filter parameters. In the present example, the GUI includes a completion status presentation control that represents aggregated counts of how many events that have occurred during the selected time range, grouped by events for which event learning data has not yet been provided (e.g., “Not Started”), events for which event learning is in progress (e.g., “In Progress”), and events for which an event learning process has been completed (e.g., “Completed”). The GUI in the present example also includes a timeline compliance status presentation control that represents aggregated counts of events for which compliance has not yet started (e.g., “Not Started”), events that are compliant (e.g., “Compliant”), and events that are overdue (e.g., “Overdue”). The GUI in the present example includes various approval status presentation controls that represent aggregated counts of how many events are waiting for particular levels of departmental approval during the event learning process (e.g., department manager approval, plant director approval, etc.). The user of the GUI, for example, can select a graphical representation of a particular event group to navigate to another GUI that provides additional information related to the event group. In the present example, the user of the GUI can select the graphical representation of the events for which event learning data has not yet been provided (e.g., “Not Started”), to receive additional information about such events.

Referring now to FIG. 4C, for example, a GUI can present an Event Learning Compliance Detail dashboard for use in the power generation environment. In the present example, the Event Learning Compliance Detail dashboard presents a list view of the events for which event learning data has not yet been provided. For each of the events, for example, various event details can be provided in the list, such as whether the event happened within a group of specific units (e.g., core generating fleet CGF), a company identifier, a plant name, a unit identifier, an event start date, an event end date, an event identifier, a fuel type, a compliance status, an event learning status, an amount of lost power (e.g., in megawatt hours), an event duration, an indicator of whether root cause analysis (RCA) is to be performed, an RCA owner, and other relevant event data. In response to a user selection of a list item that represents one of the events, for example, another GUI can be presented for annotating the event data with event learning data.

Referring now to FIG. 4D, a GUI can provide an Event Learning Details and Corrective Actions datasheet for entering, maintaining, and updating event information (e.g., entering data for a new event and/or annotating the event data for an existing event). For example, the Event Learning Details and Corrective Actions datasheet can include various text entry controls and selection controls (e.g., checkboxes, option groups, dropdown controls, etc.). In the present example, the user can use the Event Learning Corrective Actions datasheet to indicate an event title, a date/time at which an event occurred, and a plant at which the event occurred. In response to a plant selection, for example, a unit selection control can be updated to include various units of the plant. The user can select a unit that corresponds to the event, an event type, an event category, an applicability, and whether the event is a repeat event. Event applicability, for example, can indicate whether the event data may be relevant to other units across the power generation environment. If root cause analysis (RCA) is to be performed, for example, an RCA owner can be assigned to the event. The user can also provide a text description of the event (e.g., an executive summary, a summary of events, etc.)

Events can include Generating Availability Data System (GADS) events. A GADS event, for example, can be previously entered through a Generation Availability Analysis (GAA) system and reported to the North American Electric Reliability Corporation (NERC). Each GADS event is associated with a unique identifier and other GADS event data. The Event Learning Details and Corrective Actions can execute a policy (e.g., a background query or another sort of computing process) that identifies GADS events that occurred during a selected timeframe, for example, and can populate a selection control with the event identifiers. If an event that occurred in the power generation environment is a GADS event, for example, the user can select the identifier of the relevant GADS event from the selection control, and the Event Learning Details and Corrective Actions datasheet can be automatically updated to include at least a portion of the related GADS event data (e.g., GADS Related Event Description, GADS Event Capacity Type, GADS Cause Code Description, etc.). Other GADS event data (e.g., lost power, event duration, etc.) can be maintained in the background, for example. The GADS event data, for example, generally reports equipment failures and associated statistics, however the data lacks contextual information related to the event. Through the Event Learning Details and Corrective Actions datasheet, for example, the user can provide event data in addition to the GADS event data, to facilitate the identification of common causes of failure, the identification of patterns in the causes, and the prevention of future problems.

Referring now to FIGS. 4E and 4F, for example, additional text entry controls and selection controls of the Event Learning Details and Corrective Actions datasheet are shown. As shown in FIG. 4E, for example, the user can specify a failure mechanism, failure mechanism details, and a failure category. In general, at least some of the selection controls can be populated based on a previous selection. For example, a failure mechanism selection control can be populated based on a previous selection of a unit (e.g., for a Plant A Unit 1, the failure mechanism selection control can be populated with failure mechanisms that pertain to that unit). Referring now to FIG. 4F, for example, more selection controls of the Event Learning Details and Corrective Actions datasheet are shown. After selecting a failure category, for example, the user can select a failure category component (e.g., a motor), a failure category component failure mode (e.g., insulation degradation), and can indicate whether the risk was known prior to the event occurring. The failure category component failure modes are predetermined and specific for the failure category component that was selected.

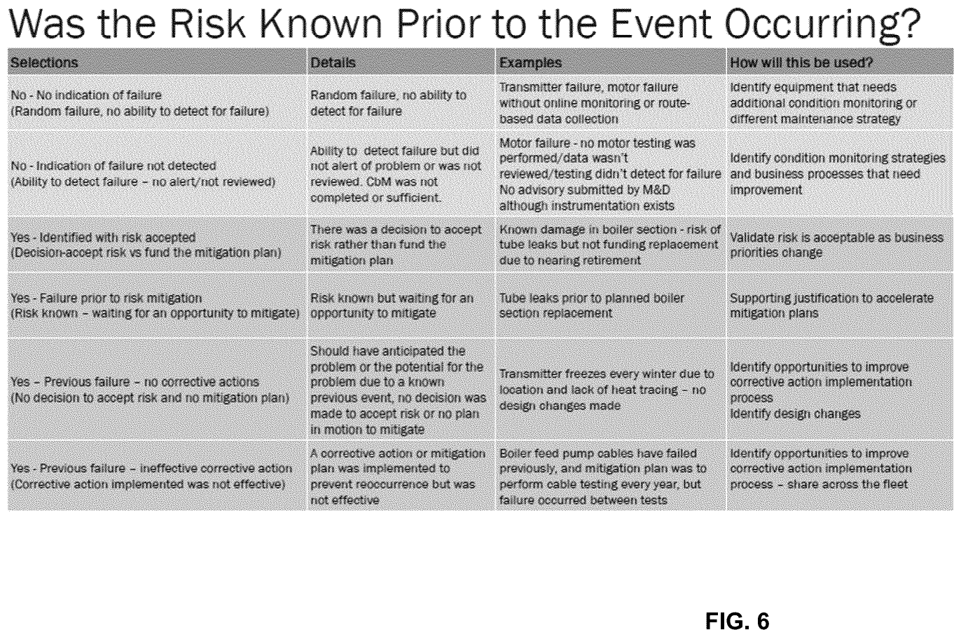

FIG. 6 is a chart that outlines possible relationships between risk knowledge and event occurrences. The chart, for example, can be used to populate the selection control for indicating whether the risk was known prior to the event. If the user indicates that there was no indication of failure (e.g., the failure was random and/or there was no ability to detect for the failure), equipment can be identified for additional condition monitoring or a different maintenance strategy. If the user indicates that an indication of failure was not detected (e.g., there was an ability to detect failure, but an alert was not generated or reviewed), condition monitoring strategies and other processes can be identified for improvement. If the user indicates that the failure was identified with the risk accepted (e.g., a decision was made to accept the risk as opposed to funding a mitigation plan), a determination can be made of whether it is acceptable to validate the risk as priorities change. If the user indicates that the failure was known prior to risk mitigation (e.g., waiting for an opportunity to mitigate), mitigation plans can be accelerated. If the user indicates that the failure was a previous failure with no corrective actions (e.g., no decision to accept risk, and no mitigation plans), opportunities can be identified to improve a corrective action implementation process, and design changes can be identified. If the user indicates that the failure was a previous failure with ineffective corrective action (e.g., an implemented corrective action was ineffective), opportunities can be identified to improve a corrective action implementation process, which can be shared across the power generation environment.

Referring again to FIG. 4F, for example, additional selection controls can be provided for collecting further data about the event. In the present example, the user can use the selection controls to indicate whether the event was related to a lack of funding, whether the event was related to poor service or material quality, whether the event involved elements related to human performance, whether the event was related to an inadequate maintenance strategy or maintenance plan, whether the event was related to an inadequate work schedule, whether the failure was related to new equipment or a new component, whether the failure was a result of cycling the unit and whether the event was related to severe cold weather. The data provided through the Event Learning Details and Corrective Actions datasheet, for example, can be used identify common causes of failure, and to identify of patterns in the causes. For example, the GADS event data and the additional event data provided through the datasheet can be stored in a database and used to train a machine learning model that identifies the data patterns. Based on the identified data patterns, for example, strategies can be developed to mitigate and prevent future problems.

Referring now to FIG. 4G, for example, a GUI can provide a Corrective Action datasheet for specifying one or more tasks (e.g., corrective actions, recommendations, etc.) for mitigating an event that occurred in the power generation environment. When a task record is generated, for example, the task can be assigned a unique identifier. In the present example, the user can select a recommendation type, an originating reference, a recommendation headline, a recommendation description (e.g., detailing a task to be performed), and a recommendation basis. The user can specify an asset identifier, an equipment technical number, and a functional location identifier. A creation date can be generated for the task record, and the user can specify a target completion date and a mandatory completion date. In general, as tasks are performed, data provided through the Event Learning Recommendation datasheet can be updated. For example, when a task is completed, a Completed Date can be specified for the task. A determination of whether a task has been completed, for example, can be performed by a worker and/or an automated system (e.g., including automated guided vehicles (AGVs), robotic devices, and/or another machines capable of performing the determination). In the present example, the user can specify a recommendation priority for the task, a notification type, an author name, and an assigned name. In some implementations, tasks can be assigned to automated systems (e.g., including automated guided vehicles (AGVs), robotic devices, and/or another machines capable of performing the task). The user in the present example can specify the issue addressed, whether a human performance element is involved, mitigation tools, a work order number, and notes. The user in the present example can also use the Event Learning Recommendation datasheet to generate a work request, specify a work request reference, work request equipment, a work request functional location, and status.

Referring now to FIG. 4H, for example, a GUI can provide an Environmental Event Learning datasheet. Similar to the Event Learning Details and Corrective Actions datasheet (shown in FIGS. 4D-4F), for example, the Environmental Event Learning datasheet can be used for entering, maintaining, and updating event information, although in an environmental context. In the present example, the Environmental Event Learning datasheet includes text entry controls and selection controls for specifying an event title, an event start date/time, a plant, a unit, a number of events, an event category, an event type, an impacted business unit, one or more notifications, a root cause category, a human performance element, one or more identified root causes, and an event description. In some examples, a GUI can provide a Safety Event Learning datasheet (not shown). The Safety Event Learning datasheet, for example, can be used for entering, maintaining, and updating event information in a safety context.

Referring now to FIG. 4I, for example, a GUI can provide a Failure Analytics dashboard for use in the power generation environment. The Failure Analytics dashboard, for example, can provide an overview of the GADS event data through various graphical representations (e.g., bar graphs, pie charts, etc.). In the present example, the Failure Analytics dashboard includes a graphical representation that shows event counts per month, along with an amount of lost power that has been attributed to the events. The Failure Analytics dashboard in the present example can also include graphical representations of aggregated event statistics, including lost power by event type per month, and a number of events by event type per month.

Referring now to FIG. 4J, for example, an event detail portion of the Failure Analytics dashboard is shown. For example, additional event data that has been provided through the Event Learning Details and Corrective Actions datasheet and which has been correlated with the GADS event data can be aggregated and presented through various graphical representations (e.g., bar graphs, pie charts, etc.). In the present example, the event detail portion of the Failure Analytics dashboard includes a graphical representation of event applicability to other units, which shows a number of events that are applicable to similar system types, plant, fleet, and region. The event detail portion of the Failure Analytics dashboard in the present example also includes a graphical representation of event reasons, which shows a number of events caused by equipment/material failure, controls malfunction or misoperation, instrument and controls equipment failure, and boiler tube failure. The event detail portion of the Failure Analytics dashboard in the present example also includes a graphical representation of repeat events, which shows a number of events that are designated as being repeat events, and a number of events that are not designated as being repeat events. Through the event detail portion of the Failure Analytics dashboard, for example, a user can gain a high level perspective of events that may occur in the power generation environment. This data is then used to identify fleet wide corrective action plans (maintenance strategy changes, design changes, procedure updates, etc.) to reduce future events.

Referring now to FIG. 4K, for example, a GUI can present an Action Tracking dashboard for use in the power generation environment. In general, the Action Tracking dashboard can be used to prioritize and track progress on tasks (e.g., corrective actions, recommendations) to be performed to mitigate (and/or prevent) event occurrences. In the present example, the Action Tracking dashboard includes a heat map that plots an amount of time that a task is overdue versus a task priority, a list of overdue actions, and a list of outstanding actions. Each task/action/recommendation in the lists, for example, can be associated with a plant, an identifier, a headline, a description, a priority, an age, a target completion date/time, a creation date/time, an assignment, an author, an approval status, an owner, a type, and other relevant data. Through the Action Tracking dashboard, for example, a user can receive a visual indication of a level of operation risk that is associated with each task (e.g., repair tasks, preventative maintenance tasks, etc.) such that tasks that are associated with high levels of operational risk (e.g., tasks for repairing and/or maintaining critical equipment) can be prioritized.

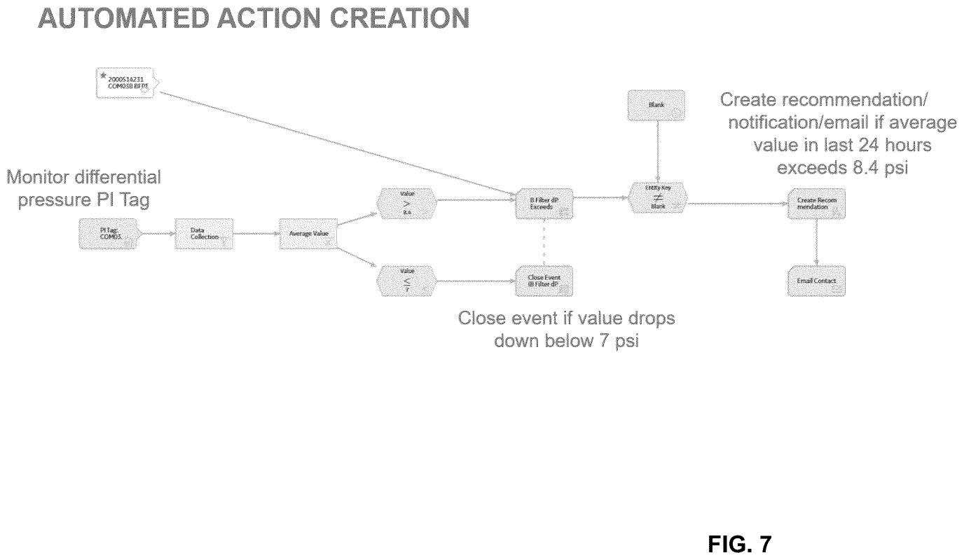

In some implementations, tasks to be performed in a power generation environment can be automatically generated. Referring now to FIG. 7, an example process for creating automated tasks is shown. For example, various automated data collection techniques (e.g., including the use of equipment sensors and digital communication) can be used to monitor the status of equipment in the power generation environment, and to provide real-time sensor data to an equipment controller that can compare the real-time sensor data to predetermined threshold values, and can perform various actions in response to the real-time sensor data crossing a threshold value. In the present example, the equipment controller can determine whether a differential pressure value drops below 7 psi, and if so, can send a close event to the power generation equipment. If the an average differential pressure value for the power generation equipment exceeds 8.4 psi, however, the equipment controller can trigger the automatic generation of a task (e.g., an action, a recommendation, etc.) to service the power generation equipment. Automatically generated tasks, for example, can exist alongside of manually generated tasks, and data related to the automatically generated tasks can be similarly reported and managed through the various GUIs described in this document.

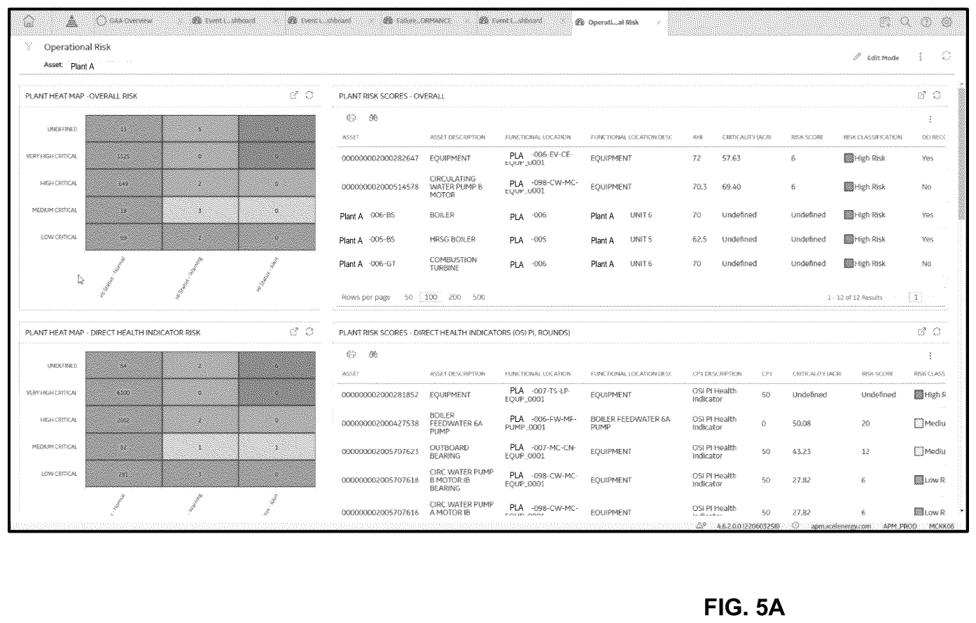

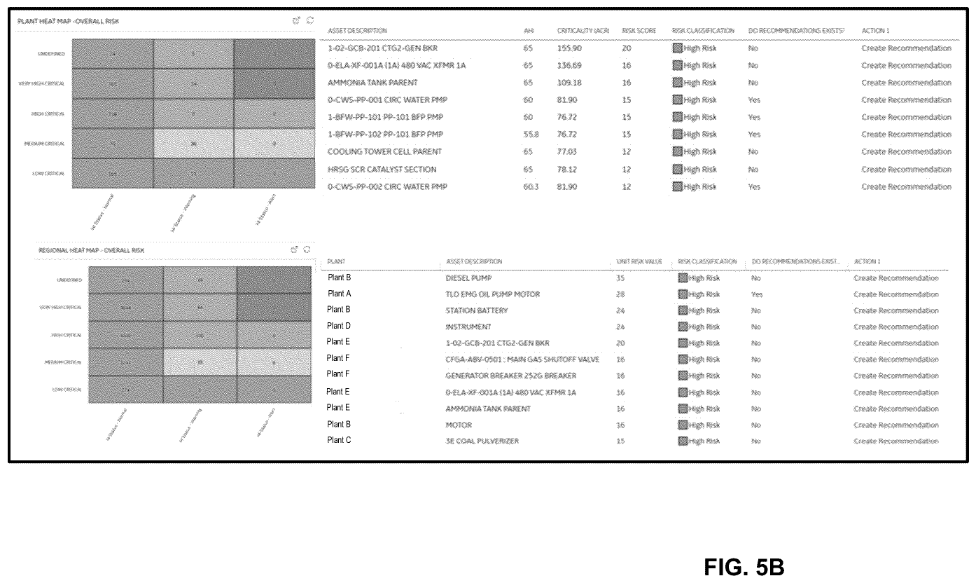

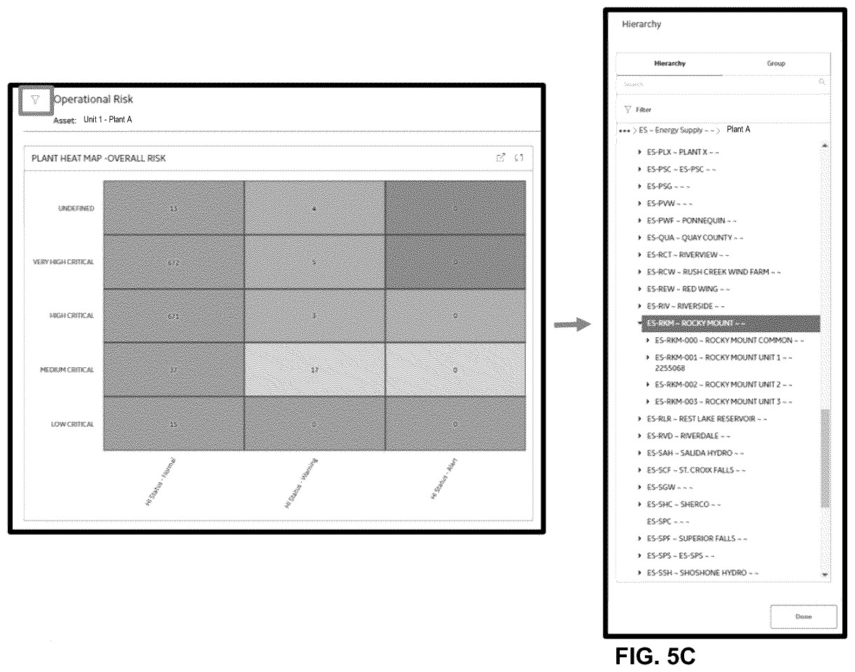

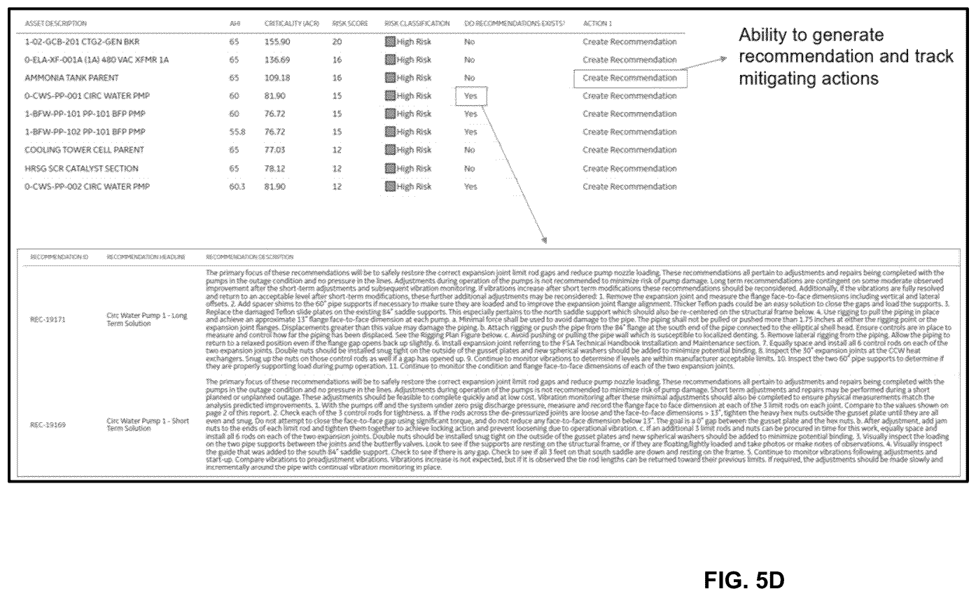

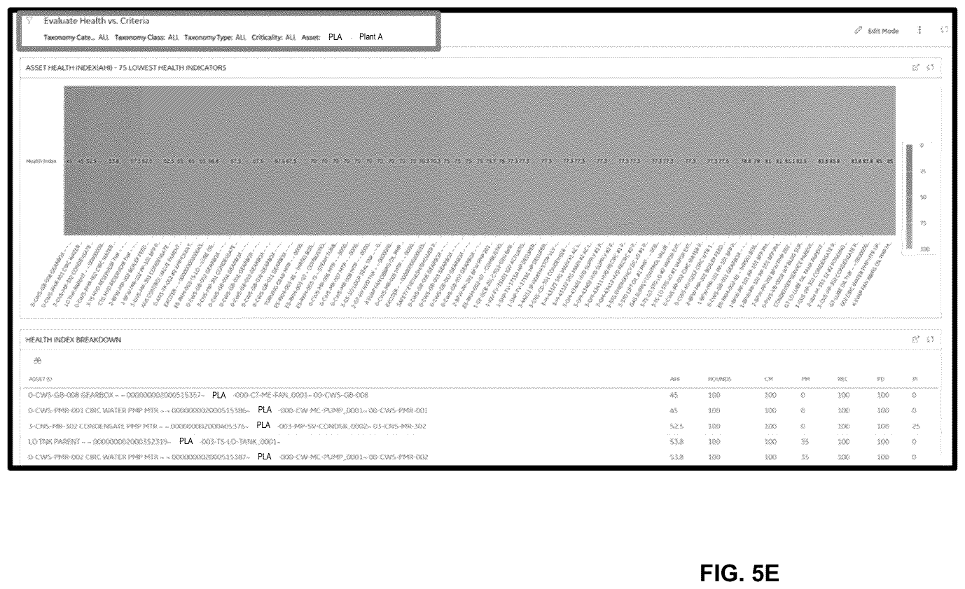

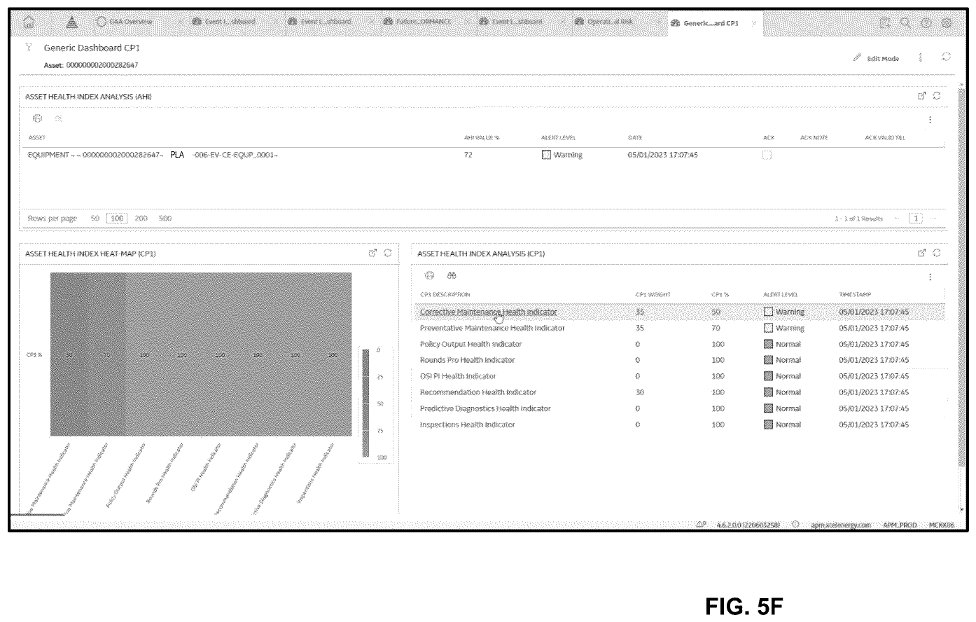

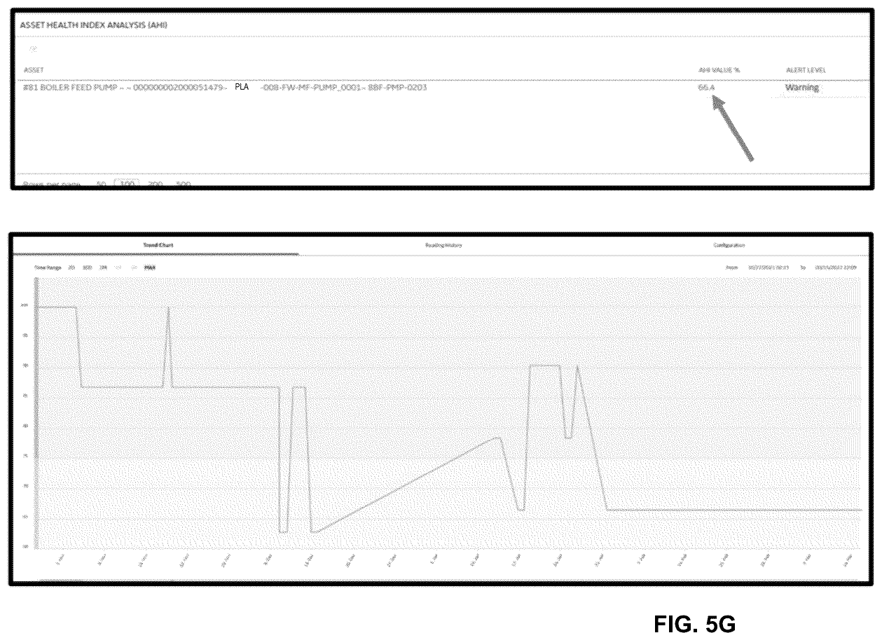

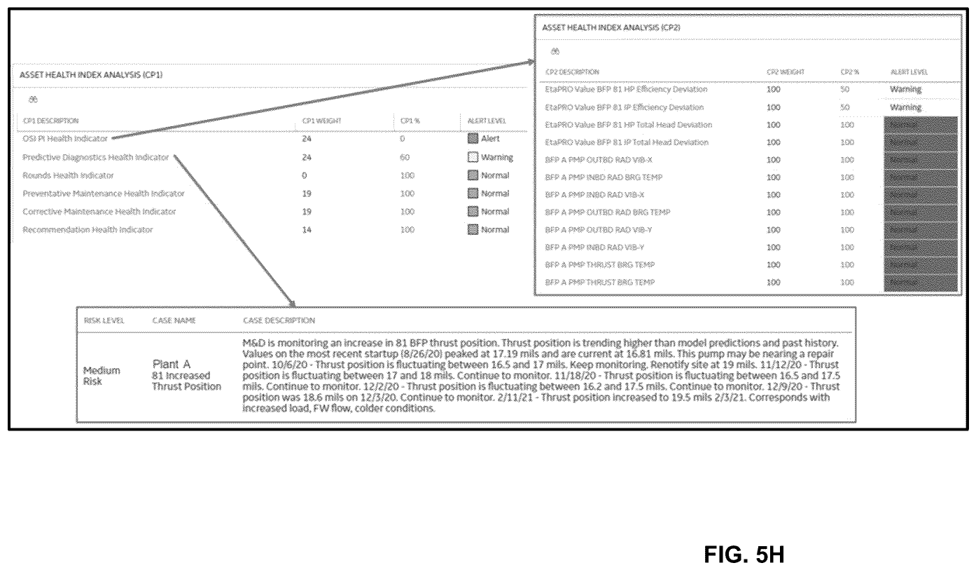

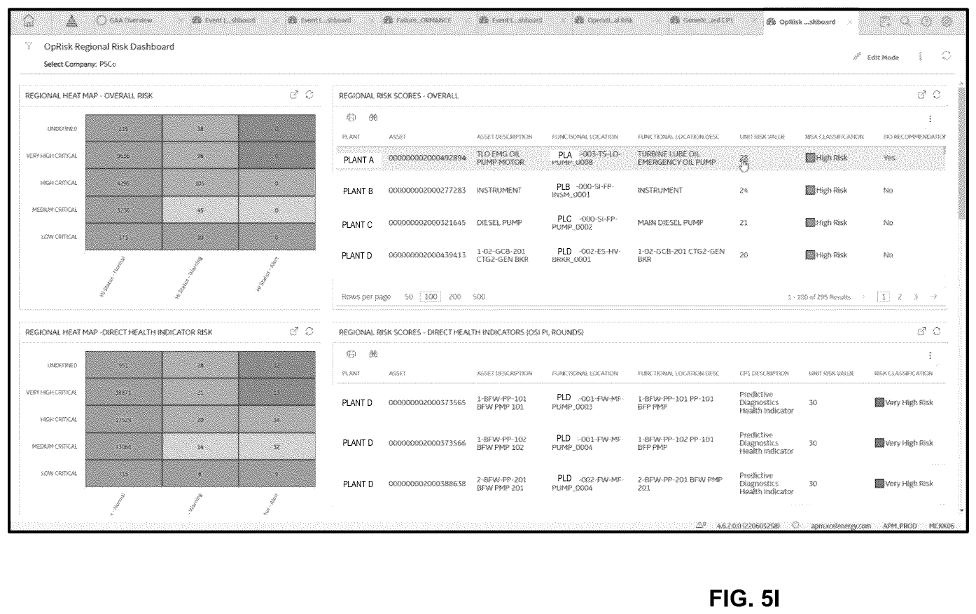

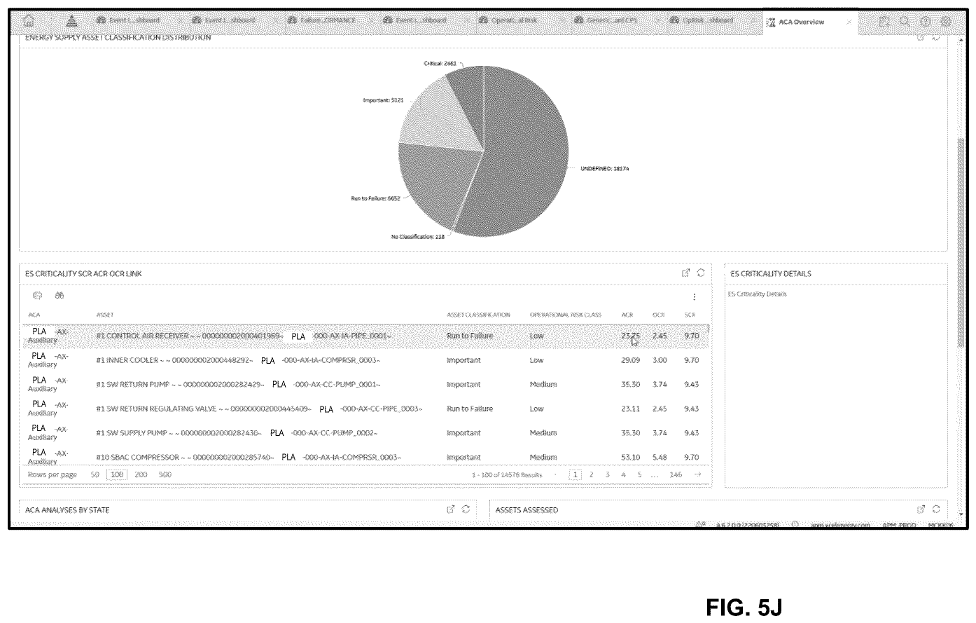

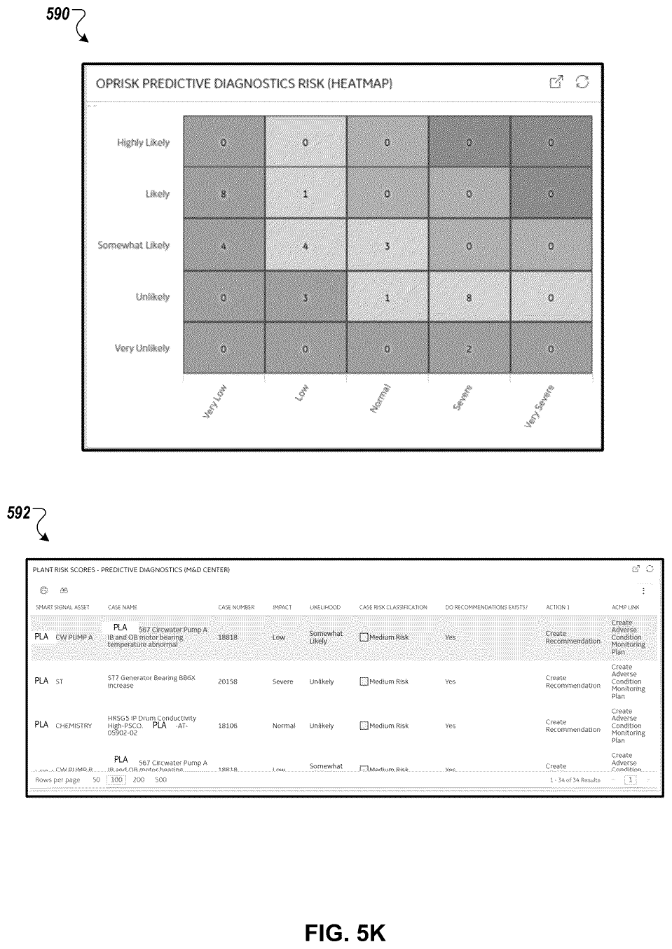

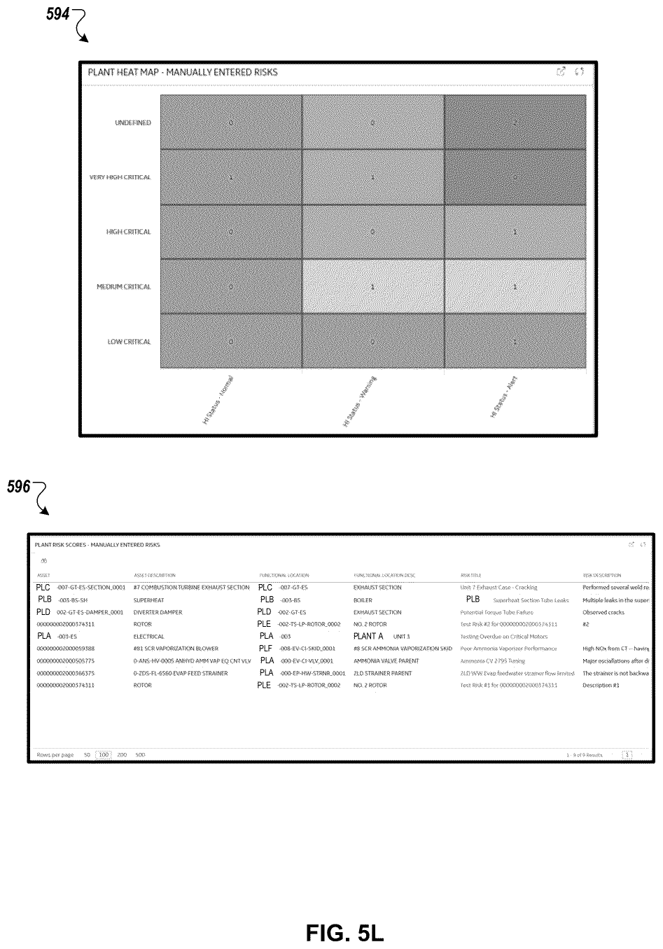

Referring to FIGS. 5A-5L, example GUIs (Graphical User Interfaces) are shown for presenting operational risk factors that have been determined for a power generation environment. The GUIs, for example, can include various dashboards, datasheets, and reports for planning maintenance and project scope based on equipment condition and risk. Data can be provided through the GUIs to inform decisions and enable the right maintenance to be performed on the right equipment at the right time, to ultimately reduce failures and maintenance cost. In general, determining operational risk factors can be based on a combination of asset criticality data and equipment condition data. For example, a critical asset (e.g., power generation equipment that is in frequent use and/or that generates a large amount of power) that is in poor condition can present a high level of operational risk, whereas a non-critical asset (e.g., power generation equipment that is in infrequent use and/or that generates a small amount of power) that is in good condition can present a low level of operational risk. Based on the determination of the operational risk factors, for example, an organization can prioritize the operation and maintenance of equipment to mitigate overall risk in the power generation environment. The GUIs also provide the ability to create and track corrective actions/recommendations for the asset alongside the risk data to ensure mitigating plans are tracked, prioritized and implemented appropriately.

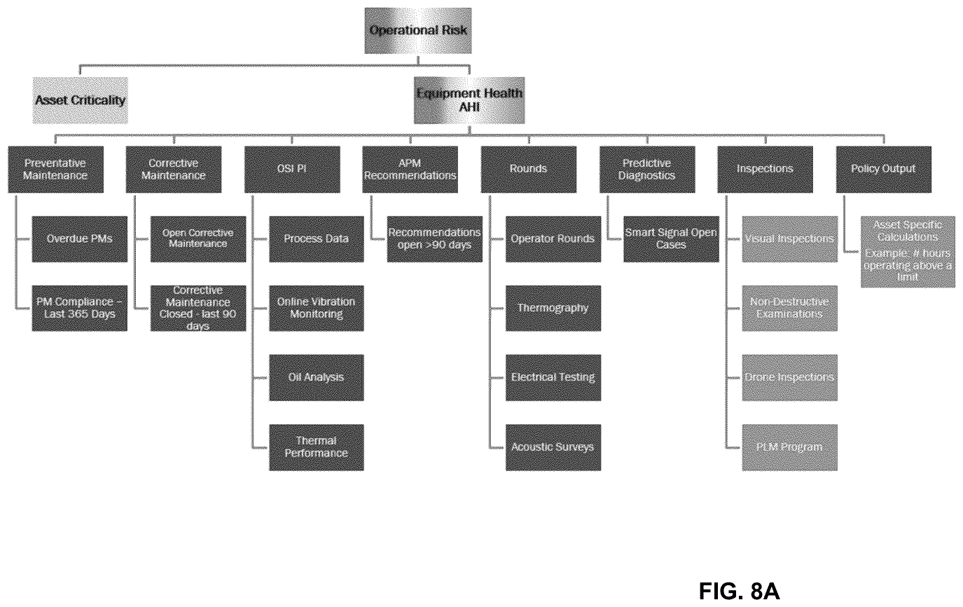

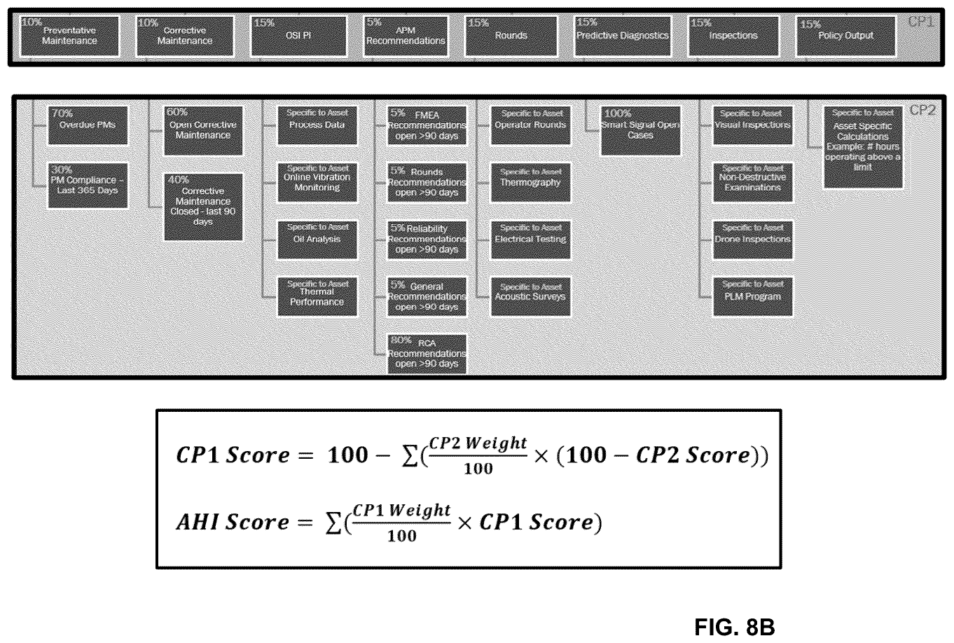

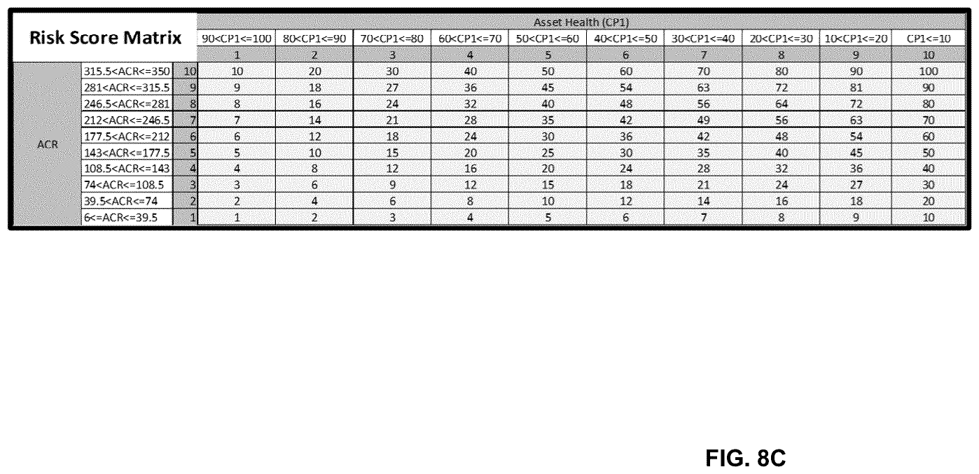

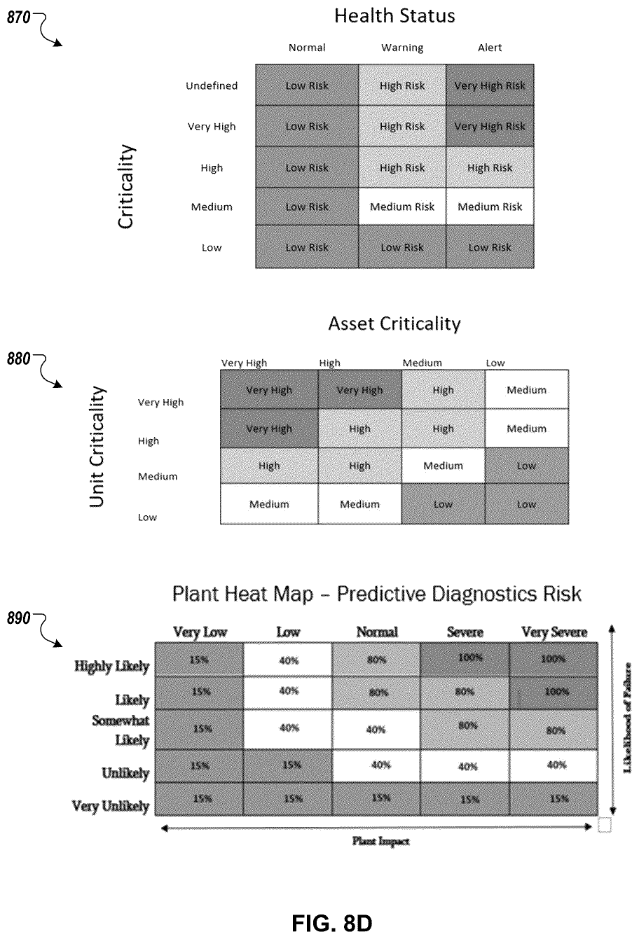

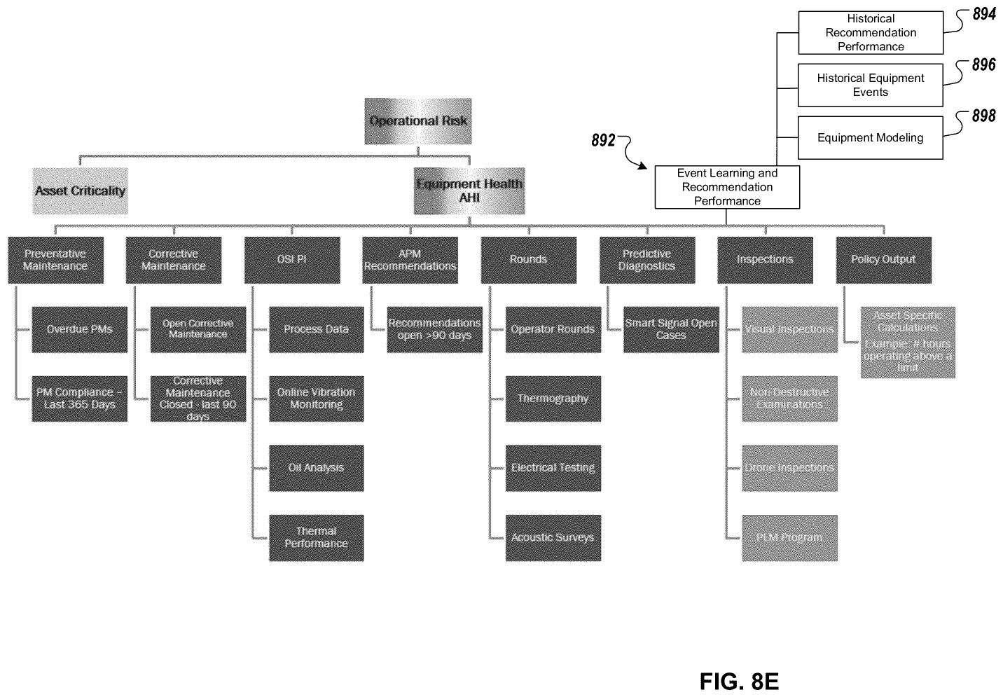

Referring to FIGS. 8A-8D, example data structures are shown for determining operational risk factors, based on equipment health and criticality data. In general, an Asset Health Index (AHI) score can be combined with an Asset Criticality score to determine an overall Operational Risk score for a piece of equipment in a power generation environment. To generate the Asset Criticality score, for example, various guidelines can be followed to evaluate the relative importance of a component part to a unit (e.g., a power generator), a unit to a plant, and a plant to a region. The Asset Criticality score, for example, can be a relatively static score that is maintained by an asset performance management system and that can be periodically changed as the guidelines and/or the configuration of the power generation environment change over time. For example, as plants are added or removed from a power generation network, as units are added, removed, or modified within a plant, equipment/process design changes are implemented, and/or when new information becomes available (e.g., based on data patterns discovered from performing machine learning on the GADS event data), Asset Criticality scores can be modified to reflect the network changes and/or new information. To generate the AHI score, for example, a policy (e.g., a background query or another sort of computing process) of an asset performance management system can receive data inputs that correspond to scores under various data categories (e.g., with at least some of the data inputs being based on data collected in real-time), and can execute an algorithm that combines the category scores to determine an overall score. An AHI score for a unit or a component part of the unit can be relatively fluid, for example, and can be generated as part of a batch process (e.g., once per day, once per hour, or at another appropriated time interval), in response to a data change (e.g., operational data that represents a current state of a piece of equipment crossing a predetermined threshold value), and/or on demand. In addition to performing score generation, for example, policies can optionally take actions on data in an automated fashion (e.g., by triggering alerts, sending notifications, sending instructions to data collection systems for gathering additional data, sending instructions to robotic systems for performing corrective actions, etc.), in response to changes in the AHI score or components thereof.

FIG. 8A is a diagram of example data categories that can serve as factors when determining an Asset Health Index (AHI) score for a piece of power generation equipment. In general, and as shown in the present example, the AHI score can be derived from an aggregation of multiple different category scores, which in turn can each be derived from an aggregation of multiple different category component scores. The various different data categories (and optionally, components of the categories) can each generally relate to a primary category that pertains to how operational risk is quantified (e.g., maintenance strategy execution, equipment health, or previous failures). Maintenance strategy execution, for example, can involve the monitoring of whether or not a maintenance strategy that has been defined for a piece of power generation equipment is actually being executed correctly. Equipment health, for example, can involve the monitoring of data that pertains to a piece of power generation equipment to determine its current condition. Previous failures, for example, can involve an analysis of data that pertains to previous failures on a piece of power generation equipment (or previous failures that have occurred on similar equipment) that highlight a potential vulnerability on the equipment.

In the present example, the overall AHI score can be a combination of a Preventative Maintenance category score (which generally relates to maintenance strategy execution), a Corrective Maintenance category score (which generally relates to equipment health and/or previous failures), an OSI PI category score (which generally relates to equipment health), an Asset Performance Management (APM) Recommendations category score (which generally relates to previous failures), a Rounds category score (which generally relates to equipment health), a Predictive Diagnostics category score (which generally relates to equipment health), an Inspections category score (which generally relates to equipment health), and a Policy Output category score (which generally relates to equipment health). The Preventative Maintenance category score, for example, can be an aggregation of an Overdue Preventative Maintenance score and a Preventative Maintenance (Last 365 Days) score. The Corrective Maintenance category score, for example, can be an aggregation of an Open Corrective Maintenance score and a Corrective Maintenance Closed (Last 90 Days) score. The OSI PI category score, for example, can be an aggregation of a Process Data score, an Online Vibration Monitoring score, an Oil Analysis score, and a Thermal Performance score. The APM Recommendations category score, for example, can be based on recommendations that have been open or overdue for a designated period of time (e.g., 90 days). The Rounds category score, for example, can be an aggregation of an Operator Rounds score, a Thermography score, an Electrical Testing score, and an Acoustic Surveys score. The Predictive Diagnostics category score, for example, can be based on Smart Signal open cases generated from a remote Monitoring & Diagnostic center. The Inspections category score, for example, can be an aggregation of a Visual Inspections score, a Non-Destructive Examinations score, a Drone Inspections score, and a Plant Life Management (PLM) Program score. The Policy Output category score, for example, can be based on asset-specific calculations. For example, the asset-specific calculations can include a number of hours that a unit (or a component part of the unit) has been operating above a defined time limit and/or has been operating above (or below) a defined temperature limit (e.g., with the defined limits being based on manufacturer specifications).

In other examples, more, fewer, or different data categories can serve as factors when determining an Asset Health Index (AHI) score, and/or the data categories can include different component scores. For example, rather than being included as part of the OSI PI category score, the Thermal Performance score can optionally be part of the Predictive Diagnostics category score. As another example, one or more inspections scores (e.g., the Drone Inspections and the Plant Life Management (PLM) Program score) can optionally be excluded as part of the Inspections category score, and/or one or more other inspections scores can be included as part of the Inspections category score. Other variations of the example data category and component score scheme are possible.

FIG. 8B is a diagram of an example weighting of data categories and component scores when determining an Asset Health Index (AHI) score for a piece of power generation equipment. In general, each category component can be scored along a predetermined scale (e.g., 0-100 with 0 being low and 100 being high, or another suitable scale), with the category component scores being aggregated to determine a category score (e.g., along a similar scale), and with the category scores being aggregated to determine the overall AHI score (e.g., also along a similar scale) for the piece of power generation equipment. In the present example, the Preventative Maintenance category score can be assigned a weight of 10%, the Corrective Maintenance category score can be assigned a weight of 10%, the OSI PI category score can be assigned a weight of 15%, the Asset Performance Management (APM) Recommendations category score can be assigned a weight of 5%, the Rounds category score can be assigned a weight of 15%, the Predictive Diagnostics category score can be assigned a weight of 15%, the Inspections category score can be assigned a weight of 15%, and the Policy Output category score can be assigned a weight of 15%. In other examples, the various data categories can be assigned different weight percentages. In some implementations, different assets can be associated with different weight percentages across the categories. In some implementations, some assets may be associated with fewer or additional categories relative to other assets.

In general, different category components can be assigned different weight values for determining a category score. In the present example, for the Preventative Maintenance category score, the Overdue Preventative Maintenance component score can have a weight of 70%, and the Preventative Maintenance (Last 365 Days) score can have a weight of 30%. For the Corrective Maintenance category score, for example, the Open Corrective Maintenance score can have a weight of 60% and the Corrective Maintenance Closed (Last 90 Days) score can have a weight of 40%. For the OSI PI category score, for example, the weights assigned to the various component scores (e.g., Process Data, Online Vibration Monitoring, Oil Analysis, and Thermal Performance) can be specific to the asset being scored. For the Asset Performance Management (APM) Recommendations category score, for example, FMEA recommendations can have a weight of 5%, Rounds recommendations can have a score of 5%, Reliability recommendations can have a weight of 5%, General recommendations can have a weight of 5%, and RCA recommendations can have a weight of 80%. For the Rounds category score, for example, the weights assigned to the various component scores (e.g., Operator Rounds, Thermography, Electrical Testing, and Acoustic Surveys) can be specific to the asset being scored. For the Predictive Diagnostics category score, for example, the Smart Signal Open Cases can have a weight of 100%. For the Inspections category score, for example, the weights assigned to the various component scores (e.g., Visual Inspections, Non-Destructive Examinations, Drone Inspections, and PLM Program) can be specific to the asset being scored. For the Policy Output category score, for example, asset-specific calculations can be used. In other examples, more, fewer, or different data component scores can be used to determine a category score, and/or the component scores can be differently weighted. An example formula for calculating a category score (e.g., a CP1 score) from its respective component scores (e.g., CP2 scores) is shown in FIG. 8B. An example formula for calculating the AHI score for an asset (e.g., a piece of power generation equipment) from its respective category scores (e.g., CP1 scores) is shown in FIG. 8B.

FIG. 8C is a diagram of an example risk score matrix that can be used to determine an overall Operational Risk score for an asset, based on the asset's Asset Criticality score and the asset's Asset Heath Index (AHI). For example, a series of bucket ranges can be defined for the Asset Criticality score (which can have a value from 6 to 350, or another suitable range of values), and another series of bucket ranges can be defined for the AHI (which can have a value from 0 to 100, or another suitable range of values). To determine an overall Operational Risk score for an asset, for example, a matrix row that corresponds to the asset's Asset Criticality score can be identified (e.g., one of the buckets 1-10 along the y-axis of the Risk Score Matrix, and a matrix column that corresponds to the asset's AHI can be identified (e.g., one of the buckets 1-10 along the x-axis of the Risk Score Matrix). The intersection of the identified matrix row and matrix column, for example, can include a data value that can be assigned as the Operational Risk score of the asset. As shown in the present example, an asset that has a high Asset Criticality score and a low Asset Health Index can be assigned a high Operational Risk score, whereas an asset that has a low Asset Criticality score and a high Asset Health Index can be assigned a low Operational Risk score.

FIG. 8D is a diagram of example risk score classifications that can be used in a power generation environment. In general, the risk score classifications can be used to generate heat maps that can be presented by various GUIs for presenting operational risk factors. The heat maps, for example, can be used to quickly identify issues in the power generation environment that may present a significant operational risk, such that resources can be appropriately directed to high-risk issues (e.g., through a manual or automatic allocation of resources). For example, if only an Asset Health Index were used to prioritize maintenance issues in a plant, equipment that is in poor condition but is part of a non-critical system (and would thus have a relatively low impact if it were to fail) would likely be prioritized over equipment that is in better condition but is part of a critical system (and would thus have a relatively high impact if it were to fail). By factoring both asset criticality and health status (per the heat maps), for example, an overall impact of equipment failures on a plant or region can be reduced.

Referring to classification matrix 870, for example, Asset Criticality can be plotted against Health Status (e.g., based on the asset's Asset Health Index (AHI)). An asset's Asset Criticality score, for example, can be classified as being low, medium, high, very high or undefined. The asset's AHI, for example, can be classified as being Normal (e.g., with a score over 75), Warning (e.g., with a score between 35 and 75), or Alert (e.g., with a score of under 35). In the present example, assets with a Normal AHI can be designated as being low risk, assets with a Warning AHI can be designated as being from low risk (e.g., if the Asset Criticality is low) to high risk (e.g., if the Asset Criticality is high or undefined), and assets with an Alert AHI can be designated as being from low risk (e.g., if the Asset Criticality is low) to very high risk (e.g., if the Asset Criticality is very high or undefined).

Referring to classification matrix 880, for example, a combination of Asset Criticality and Unit Criticality can be evaluated to determine an overall Criticality classification for an asset. In general, an Asset Criticality classification for an asset can be adjusted based on the Unit Criticality classification of a unit of which the asset is a component part. For example, if a given asset (e.g., piece of equipment) were to have an Asset Criticality of medium, and the asset is a component of a unit (e.g., a power generation device) with a high Unit Criticality classification (e.g., a unit that has high importance to a plant and/or region), the asset's criticality classification can be adjusted higher. As another example, if the asset were to be a component of a unit with a low Unit Criticality classification (e.g., a unit that has low importance to a plant and/or region), the asset's criticality classification be adjusted lower. By factoring in the relative criticality of a unit in which an asset is a component part, for example, the operation and maintenance of assets across an entire plant (or region) can be appropriately prioritized to keep critical units running. For example, the adjusted criticality classification of the asset can be plotted against the asset's Health Status (e.g., as shown in classification matrix 870) to determine an overall risk associated with the asset in the context of a plant or region that includes multiple units.

Referring to classification matrix 890, for example, a plant heat map is shown that illustrates predictive diagnostics risk associated with cases/advisories generated from a remote Monitoring & Diagnostics Center. In the present example, plant impact is plotted against a likelihood of failure. For assets that are very unlikely to fail, and/or would have a very low impact on a plant if they were to fail, the assets/cases/advisories can be associated with a low predictive diagnostic risk. In contrast, assets/cases/advisories that are highly likely to fail and that would have a very severe impact if they were to fail can be associated with a high predictive diagnostic risk.

Referring now to FIG. 5A, for example, a GUI can provide an Operational Risk dashboard for use in a power generation environment. In general, the Operational Risk dashboard can be employed for identifying risks to assets in the power generation environment, and managing tasks for mitigating the asset risks to prevent operational failures. Similar to the various GUIs for determining causes and applying corrective actions for events (e.g., as shown in FIGS. 4A-4K), the various GUIs for presenting operation risk factors can include one or more controls for selecting a particular region in the power generation environment, for selecting a plant of the selected region, and for selecting a unit/system/subsystem/asset of the selected plant.

As shown in FIG. 5C, for example, in response to a user selection of a data filter control, a power generation environment hierarchy control can be presented which includes a list of regions. Under a selected region, for example, the hierarchy control can present a list of plants that are associated with the selected region. Under a selected plant, for example, the hierarchy control can present a list of units that are associated with the selected plant. The Operational Risk dashboard can be updated to present corresponding asset risk data at a selected region, plant, or unit/system/subsystem/asset level, for example.

Referring again to FIG. 5A, for example, the Operational Risk dashboard includes a plant heat map that represents Overall Risk across a selected plant, and another plant heat map that represents Direct Health Indicator Risk. The plant heat map that represents Overall Risk, for example, can be based on calculated risk factors using the Asset Health Index (AHI) as described with respect to FIG. 8A. The plant heat map that represents Direct Health Indicator Risk, for example, can be based on calculated risk factors using a portion of the categories included in the AHI (e.g., the CP1 scores from the OSI PI Health Indicators, the Rounds Health Indicators, the Inspections Health Indicators, and the Policy Output Health Indicators) as described with respect to FIG. 8A. Counts of the evaluated plant assets (e.g., assets that have been scored according to Asset Criticality and Asset Health Index) can be determined for each cell in each heat map matrix, for example, such that high risk assets (e.g., critical assets with low health scores) can be quickly identified. In the present example, each plant heat map can be associated with a corresponding risk ranking data presentation area, which can present, for each ranked asset, an asset identifier, an asset description, a functional location, a functional location description, an Asset Health Index (AHI), an Asset Criticality Ranking (ACR), an overall Risk Score, and a Risk Classification (e.g., according to a risk matrix). The risk ranking data presentation areas, for example, can sort the assets by overall Risk Score, with high risk assets being presented at the top of a list.

Referring now to FIG. 5B, for example, an expanded view of the Operational Risk dashboard is shown. For each list item in the risk ranking data presentation areas, for example, an indication can be provided of whether recommendations (e.g., defined tasks, actions, etc.) already exist for mitigating the risk to the asset. Further, a control can be provided for each list item to facilitate the generation of a task for the asset risk. For example, a user can select a recommendation generation control for an asset risk, and in response the Operational Risk dashboard can provide a control for entering data related to one or more tasks for mitigating the risk. In some implementations, the generation of a task for mitigating an asset risk can be facilitated through a machine learned data pattern. For example, in response to receiving the selection of a control for generating a task for mitigating a risk to an asset, data related to historical instances of mitigating similar risks can be identified (e.g., based on category scores of the asset's AHI), and used for suggesting an appropriate mitigation recommendation for the asset. In some implementations, tasks for mitigating asset risks can be automatically generated and tracked. For example, in response to an overall Risk Score for an asset crossing a threshold value (e.g., a High Risk), a computer system of the power generation environment can automatically generate a suitable task for mitigating the risk to the asset.

Referring now to FIG. 5D, for example, recommendation data is shown for an asset risk. Each recommendation (e.g., a defined task, action, etc.), for example, can be assigned a recommendation identifier, a recommendation headline (e.g., a short description), a recommendation description (e.g., a long description), a target completion date, a priority and an assigned worker (e.g., a human worker and/or an automated device). In the present example, the selected asset is associated with a high risk classification, and two different recommendations have been generated for mitigating the risk to the asset. Each recommendation, for example, can be tracked throughout the system (e.g., including manual and/or automated processes for providing recommendation task notifications and/or determining if and when the recommendation task has been completed), and the asset's Health Index can be adjusted in response to determining whether the recommendation(s) have been completed. If the recommendation tasks have been completed, for example, the asset's Health Index can be increased (e.g., as a result of a favorable Corrective Maintenance and/or Recommendation category score), whereas if the recommendation tasks have not been completed, the asset's Health Index can be decreased (e.g., as a result of an unfavorable Corrective Maintenance and/or Recommendation category score).

Referring now to FIG. 5E, for example, a GUI can provide a list of assets, ranked according to Asset Health Index (AHI), with assets having low health index scores being placed at the top of the list. The GUI shown in FIG. 5E, for example, can provide an overview of the asset health scores across a region, plant, or unit, independent of asset criticality. To view the specific health score data of an individual asset, for example, the asset can be selected from the Health Index Breakdown list. As discussed throughout this document, the asset health scores depicted in this GUI can be incorporated into and used in combination with criticality scores to determine and provide operational risk scores for assets.

Referring now to FIG. 5F, for example, a GUI can provide an Asset Health Index dashboard for use in the power generation environment. As discussed throughout this document, the asset health score information depicted in this GUI can be used in combination with criticality scores to determine and provide operational risk scores for assets. The Asset Health Index (AHI) dashboard can display a detailed analysis of the AHI for an asset. In the present example, the AHI dashboard includes an asset identifier/description, an AHI value for the asset, an alert level for the asset, and a date/time at which the AHI was calculated. The AHI dashboard in the present example can also include a heat map for the AHI scores per category, and a breakdown list of the various categories that had been evaluated to generate the AHI score (e.g., the categories shown in FIG. 8A), including each category score, weight, alert level, and date/time at which the category score was generated. In response to a selection of one of the category scores (e.g., CP1%), a GUI can be provided that shows a trend chart of score changes over time (as shown in FIG. 5G). In response to a selection of one of the category descriptions (e.g., CP1 Description), a GUI can be provided that shows a breakdown of the individual component scores that were used to determine the category score (as shown in FIG. 5H).

Referring now to FIG. 5I, for example, a GUI can provide a Regional Risk dashboard for use in the power generation environment. In general, the Regional Risk dashboard can be employed for identifying risks to assets in the power generation environment at a regional level, and managing tasks for mitigating the asset risks to prevent operational failures. The heat maps and lists can be similar to those provided by the Operational Risk dashboard (shown in FIG. 5A), however instead of using an Asset Health Index (AHI) to determine a Risk Classification, the scoring mechanism for the Regional Risk dashboard can use a Unit Risk Value (e.g., as described with respect to FIG. 8D) to determine the Risk Classification.

Referring now to FIG. 5J, for example, a GUI can provide an Asset Criticality Ranking (ACR) datasheet. Through the ACR datasheet, for example, Asset Criticality scores can be maintained for various assets in the power generation environment. In the present example, each asset can be associated with an asset identifier/description, an asset classification (e.g., Critical, Important, Run to Failure, etc.), operational risk classification (e.g., Low, Medium, High, Very High) and an ACR. After a periodic assessment, for example, a user can update an asset's ACR. As discussed throughout this document, the asset health score information depicted in this GUI can be used in combination with criticality scores to determine and provide operational risk scores for assets.

Referring now to FIG. 5K, for example, a GUI can provide a Predictive Diagnostics Risk heat map 590 and a Predictive Diagnostics widget 592. The Predictive Diagnostic heat map 590, for example, can display a number of risks (e.g., open cases integrated from a separate Advanced Pattern Recognition (APR) software utilized by a remote monitoring and diagnostics center) identified in each box of the matrix. In the present example, The y-axis can correspond to a probability of failure for each monitoring and diagnostic case (e.g., Very Unlikely, Unlikely, Somewhat Unlikely, Likely, Highly Likely) and the x-axis can correspond to the consequence of failure for each case (e.g., Very Low, Low, Normal, Severe, Very Severe). The Predictive Diagnostics widget 592 that corresponds to the Predictive Diagnostic Risk heat map 590 can list the monitoring and diagnostics cases and the associated risk classifications, based on the probability and consequence of failure. For each monitoring and diagnostics case, for example, the widget 592 can list a Smart Signal Asset (e.g., the name of the asset in the separate APR software), a Case Name (e.g., the name of the case), Case Number (e.g., the number of the case), Impact (e.g., the selected consequence of failure associated with the case), Likelihood (e.g., the selected probability of failure associated with the case), Case Risk Classification (e.g., the risk classification based on the impact and likelihood, as determined by the Predictive Diagnostics heat map 590), and a control for generating a task (e.g., a recommendation, a corrective action) for the case. An Adverse Condition Monitoring Plan can be created in response to a user selection of the corresponding control, for example. In response to a user selection of a Smart Signal Asset, for example, a list of open cases can be presented for the selected asset. In response to a user selection of a Case Name, for example, a list of equipment that case is related to can be presented, along with additional case information.

Referring now to FIG. 5L, for example, a GUI can provide a Manually Entered Risks heat map 594 and a Manually Entered Risks widget 596. The Manually Entered Risks heat map 594, for example, can display a number of risks (e.g., manually entered risks that have an “open” status) identified in each box of the matrix. In the present example, the y-axis can correspond to an asset criticality operational risk classification (Low, Medium, High and Very High) and the x-axis can correspond to a health status specified when entering a manual risk record. Based on the asset selected when entering a manual risk, for example, the asset criticality can automatically be incorporated to calculate the risk classification. If a criticality assessment has not been completed on the asset, for example, the user can manually enter the criticality classification. The Manually Entered Risks widget 596 that corresponds to the Manually Entered Risks heat map 594 can list the manually entered risks that are in “open” status. For each manually entered risk, for example, the widget 596 can list a Risk Title (e.g., a title of the risk based on user input when entering the risk record), a Risk Description (e.g., a description of the risk based on user input when entering the risk record), a Health Status (e.g., a status selected by a user when entering the risk record, such as Alert, Warning, Normal, etc.) and a Risk Classification. In response to a user selection of a Risk Title, for example, a datasheet can be presented for the manually entered risk record. In the present example, the widget 596 can also list an Asset identifier, an Asset Description, a Functional Location, and a Functional Location Description. This functionality provides a means to enter risk information manually that would not be identified automatically. The outcome is a single database used to manage all equipment and operational risks and corrective actions associated with those risks.

FIG. 8E is similar to FIG. 8A, but additionally includes event learning and recommendation/work order performance 892 as a signal further indicating equipment health scores. The equipment learning and recommendation/work order performance 892 can be influenced by any of a variety of factors, such as equipment modeling 898, historical equipment events 896, and/or historical equipment recommendation/work order performance 894. For example, equipment that has a known pattern of failure across facilities and for which prospective work orders have been generated but not performed may have a lower equipment health score than similar equipment where those prospective work orders were performed within the scheduled timeframe. Such an assessment, for example, can be performed by analyzing data that indicates that overdue recommendations exist for a piece of equipment (e.g., a recommendation has been open over 90 days, or another suitable amount of time, without being completed), which may be included as a component score under the Asset Performance Management (APM) Recommendations category. If a recommendation has been generated for the piece of equipment to perform equipment servicing and/or to update a procedure (e.g., as a result of a previous failure of the equipment and/or similar equipment), fulfilment of the recommendation can be tracked over time, and equipment health scores and corresponding risk scores can be appropriately adjusted. For example, if an unfulfilled and overdue recommendation exists for the piece of equipment, the equipment health score can be lowered, whereas if an unfulfilled and overdue recommendation does not exist, the piece of equipment's heath score can remain unaffected.

In some implementations, equipment learning and recommendation/work order performance monitoring can include an assessment of a duration of a current condition. For example, an amount of time that a recommendation for a piece of equipment remains unfulfilled and overdue can be used to proportionally adjust an equipment health score for the piece of equipment (e.g., with the score being negatively adjusted by a value that is proportional to the amount of time). Thus, in the present example, with other factors being constant, the piece of equipment's health score will be lowered and the corresponding risk score will be increased over time, in the absence of fulfillment of the recommendation. In general, the assessment can be performed through the execution of a policy (e.g., a background query or another sort of computing process) that is configured to compare current values to predetermined threshold values in an automated fashion, and that is configured to recalculate the piece of equipment's health score and corresponding risk score at appropriated times (e.g., at set intervals and/or in response to observed operational data values meeting predefined data threshold values).

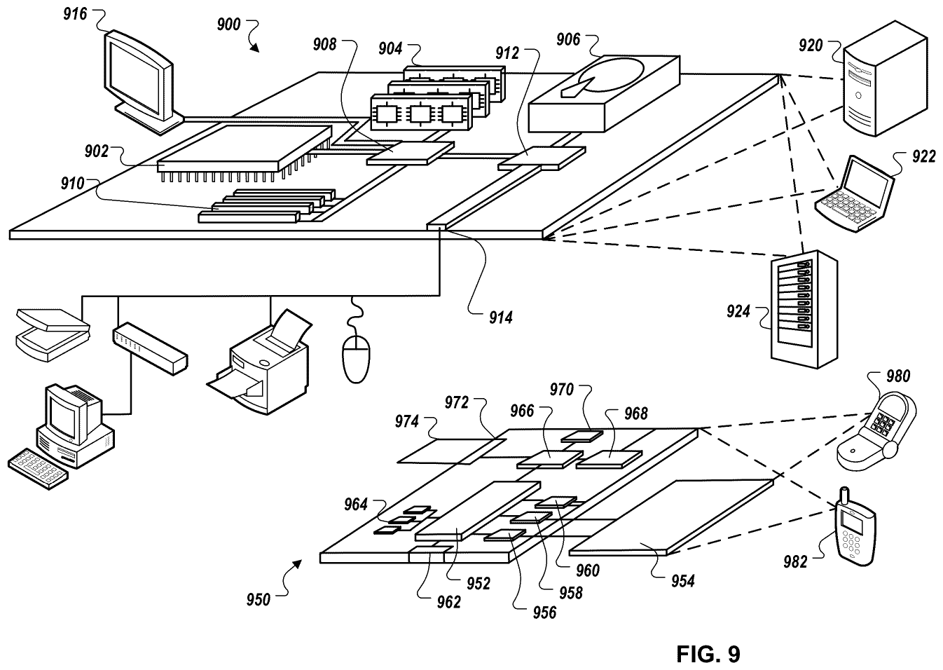

FIG. 9 shows an example of a computing device 900 and an example of a mobile computing device 950 that can be used to implement the techniques described here. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computing system for assessing operational risk in a facility, the system comprising:
one or more processors; and
one or more storage devices storing instructions that, when executed by the one or more processors, cause the one or more processors to perform operations comprising:
accessing, from a database for an asset performance management (APM) system, asset health scores for a plurality of assets in the facility, wherein each of the asset health scores indicate a likelihood that a corresponding asset will fail or be operationally impaired within a threshold period of time;
identifying criticality scores for the plurality of assets in the facility, wherein each of the criticality scores indicate a degree of importance of the corresponding asset to operation of the facility or an enterprise to which the facility belongs;
determining, based on the asset health scores and the criticality scores, operational risk scores for the plurality of assets in the facility, wherein each of the operational risk scores indicate a risk posed to the ongoing operation of the facility or to the enterprise by the corresponding asset;
determining one or more actions and corresponding action prioritizations to recommend for each of the plurality of assets based, at least in part, on the operational risk scores;
ranking the plurality of assets based on the operational risk scores; and
outputting, in a user interface, information identifying the plurality of assets ranked based on the operational risk scores, wherein the information includes the operational risk scores, the one or more actions for each of the plurality of assets, and the action prioritizations for the one or more actions.

2. The system of claim 1, wherein the one or more actions comprise corrective actions.

3. The system of claim 1, wherein the one or more actions comprise maintenance actions.

4. The system of claim 1, wherein the information includes one or more selectable features, selection of which schedules work orders for the one or more actions.

5. The system of claim 4, wherein the APM system is configured to track performance of the work orders.

6. The system of claim 1, wherein the information includes the asset health scores and the criticality scores.

7. The system of claim 1, wherein the asset health score is continually updated based on sensor signals related to the plurality of assets, operation information for the assets, observations of the assets, and work status information indicating whether work orders scheduled for the plurality of assets have been performed and completed within prescribed timeframes.

8. The system of claim 7, wherein the asset health score for an asset is decreased in response to work orders scheduled for the asset not having been performed within the prescribed timeframes.

9. The system of claim 1, wherein:
the facility is part of a plurality of facilities that service a common region, and
the criticality score further indicates a degree of importance of the facility to the service provided to the common region.

10. The system of claim 1, wherein:
the plurality of components are each positioned within a hierarchy of systems and subsystems within the facility,
the criticality score is identified based on criticality information relating degrees of importance of systems, subsystems, and assets to each other within each level of the hierarchy.

11. The system of claim 1, wherein the instructions are executed as a configuration or application that is run on the APM system.

12. The system of claim 1, wherein the instructions are executed separate from the APM system and are configured to interface with the APM system over one or more networks.

13. A computing system for assessing operational risk in a facility, the system comprising:
one or more processors; and
one or more storage devices storing instructions that, when executed by the one or more processors, cause the one or more processors to perform operations comprising:
accessing, from a database for an asset performance management (APM) system, event reporting data for an event resulting in reduction of production or other business consequence by the facility;
outputting, in a user interface, prompts for one or more authorized workers in the facility to provide additional information related to the event, wherein the prompts include identification of one or more assets within the facility that are associated with the event;
storing, in the database for the APM system, the additional information and associations between the event reporting data, the additional information, and identifiers for the one or more assets;
determining, based on the additional information and the event reporting data, one or more corrective actions for each of the one or more assets; and
outputting, in the user interface, the one or more corrective actions for each of the one or more assets, wherein the one or more corrective actions is output with selectable features, selection of which, causes work orders to be scheduled for the for the one or more corrective actions.

14. The system of claim 13, wherein the APM system is configured to track and manage performance of the work orders.

15. The system of claim 13, further comprising:
generating, based on (i) the event reporting data, the additional information, and the one or more corrective actions for the one or more assets and (ii) data for other similar assets, asset models for the one or more assets, wherein the asset models represent trends and issues for assets of a common type.

16. The system of claim 15, further comprising:
automatically generating, based on the asset model, one or more prospective actions for the other similar assets, wherein the one or more prospective actions are configured to address the trends and issues for the modeled assets.

17. The system of claim 13, wherein the instructions are executed as a configuration or application that is run on the APM system.

18. The system of claim 13, wherein the instructions are executed separate from the APM system and are configured to interface with the APM system over one or more networks.

19. The system of claim 13, wherein the event reporting data comprises generating availability data (GADS) event reporting data.
